(19) United States
(12) Patent Application Publication
(10) Pub. No.: US 2015/0254800 A1
(43) Pub. Date: Sep. 10, 2015

(54) NITROGEN STATUS DETERMINATION IN GROWING CROPS

(71) Applicant: F12 SOLUTIONS, LLC, MANKATO, MN (US)

(72) Inventors: Jerome D. Johnson, Waterville, MN (US); Tyler John Nigon, Minneapolis, MN (US)

(21) Appl. No.: 14/637,588

(22) Filed: Mar. 4, 2015

Related U.S. Application Data
(60) Provisional application No. 61/948,878, filed on Mar. 6, 2014.

(51) Int. Cl. G06T 3/00; G06K 9/52; G06K 9/46; G06K 9/62; C05C 11/00; G06Q 50/02

(52) U.S. Cl. CPC G06T 3/0012; C05C 11/00; G06Q 50/02; G06K 9/46; G06K 9/6267; G06K 9/52; G06K 2009/4666

(57) ABSTRACT

In one example, a method includes receiving, by a computing device, image data for a region of interest that includes growing crops, and identifying, by the computing device, one or more portions of the image data that correspond to the growing crops and one or more portions of the image data that correspond to an absence of the growing crops. The method further includes determining, by the computing device, based on the one or more portions of the image data that correspond to the growing crops and excluding the one or more portions of the image data that correspond to the absence of the growing crops, a nitrogen stress status of the growing crops within the region of interest.

### CROSS-REFERENCE TO RELATED APPLICATION

This application claims priority to Application 61/948,878, filed on Mar. 6, 2014, and entitled DETERMINING AND PREDICTING THE STATUS OF NITROGEN IN GROWING CORN AND ALERTING USERS, the entire contents of which are hereby incorporated by reference.

### BACKGROUND

The present disclosure relates to computing devices, and more particularly to computing devices that can use spectral imaging techniques to determine a nitrogen stress status in growing crops.

Agricultural crops, such as corn, wheat, and potatoes benefit from having an appropriate amount of available nitrogen fertilizer at various stages of growth. Studies have quantified the impact of crop nitrogen deficiency on yield beginning at, for example, a six leaf development stage of corn. To minimize the impact of nitrogen deficiency (or stress) on crop yield, it is common practice to over-apply nitrogen prior to the six leaf development stage in an attempt to reduce the chance that a crop may face nitrogen deficiency that can reduce overall yield of the crop. However, over-applying nitrogen in anticipation of the plant's future agronomic needs can lead to excessive loss of nitrogen into the environment, primarily via leaching through the soil profile (aqueous loss) and nitrification into the atmosphere (gaseous loss). Such nitrogen loss can have negative environmental impacts, such as the possible degradation of ground and surface water resources resulting in eutrophication and non-potable water supplies. Moreover, because nitrogen fertilizer can be one of the most expensive crop inputs in a grower's budget, there can be significant economic benefit to applying nitrogen at the correct times, in the correct amounts, and in the correct place to help maximize crop yield while minimizing an amount of excess nitrogen waste.

To this end, the color (e.g., “greenness”) of a corn plant, which is sensitive to its nitrogen status, as well as other factors, has been used to determine the amount of nitrogen within the plant and as such, its nitrogen status (or nitrogen stress level). For instance, spectral vegetation indices have been used to determine the relative variability of crop nitrogen uptake across a field (e.g., the crop nitrogen status in one area of a field compared to another part of the field). Other methods include soil tests and tissues analysis.

### SUMMARY

In one example, a method includes receiving, by a computing device, image data for a region of interest that includes growing crops, and identifying, by the computing device, one or more portions of the image data that correspond to the growing crops and one or more portions of the image data that correspond to an absence of the growing crops. The method further includes determining, by the computing device, based on the one or more portions of the image data that correspond to the growing crops and excluding the one or more portions of the image data that correspond to the absence of the growing crops, a nitrogen stress status of the growing crops within the region of interest.

In another example, an apparatus includes at least one processor and a computer-readable storage medium. The computer-readable storage medium is encoded with instructions that, when executed, cause the at least one processor to receive image data for a region of interest that includes growing crops and identify one or more portions of the image data that correspond to the growing crops and one or more portions of the image data that correspond to an absence of the growing crops. The computer-readable storage medium is further encoded with instructions that, when executed, cause the at least one processor to determine, based on the one or more portions of the image data that correspond to the growing crops and excluding the one or more portions of the image data that correspond to the absence of the growing crops, a nitrogen stress status of the growing crops within the region of interest.

In another example, a system includes a traversal device configured to traverse a region of interest that includes growing crops, an image sensor configured to be carried by the traversal device and to capture image data including reflectance data within a plurality of narrowband wavelength ranges, at least one processor, and a computer-readable storage medium. The computer-readable storage medium is encoded with instructions that, when executed, cause the at least one processor to receive the captured image data for the region of interest from the image sensor, and identify, based on the reflectance data, one or more portions of the image data that correspond to the growing crops and one or more portions of the image data that correspond to an absence of the growing crops. The computer-readable storage medium is further encoded with instructions that, when executed, cause the at least one processor to determine, based on the reflectance data, at least one spectral index value associated with a nitrogen content of the growing crops within the region of interest, and determine, based on the at least one spectral index value, a nitrogen stress status of the growing crops within the region of interest.

### BRIEF DESCRIPTION OF THE DRAWINGS

FIG. 1 is a block diagram illustrating an example N determination system, in accordance with one or more aspects of this disclosure.

FIG. 2 is a block diagram illustrating further details of one example of a server device shown in FIG. 1.

FIG. 3 is a block diagram illustrating further examples of a database illustrated in FIG. 1.

FIG. 4 illustrates an example geographic information system (GIS) that can be used to determine a nitrogen status.

FIG. 5 is a flow diagram illustrating example operations to determine a current nitrogen status and automatically output at least one alert.

FIG. 6 is a flow diagram illustrating example operations to determine a future nitrogen status and automatically output at least one alert.

FIG. 7 is a flow diagram illustrating further details of the operations of FIG. 5.

FIG. 8 is a flow diagram illustrating further details of the operations of FIG. 5.

FIG. 9 is a flow diagram illustrating further details of the operations of FIG. 5.

FIG. 10 is a flow diagram illustrating further details of the operations of FIG. 5.

FIG. 11 illustrates a table that represents an example scoring matrix for use in a method of determining a nitrogen status of growing crops within a region of interest.

FIG. 12 illustrates a table that represents example calculations that can be used to determine a nitrogen status of growing crops within a region of interest.

FIG. 13 illustrates tables that represent example calculations that can be used to determine a sub-category value for use in the example scoring matrix of FIG. 11.

FIG. 14 illustrates a graph of nitrogen uptake capabilities over a corn plant's growth stages.

FIG. 15 illustrates example images that can be used to determine a nitrogen status for a region of interest.

FIG. 16 illustrates and example user interface including an alert.

FIG. 17 is a block diagram illustrating an example spectral index data map that can be used to determine a nitrogen stress status of growing crops based on image data corresponding to the growing crops and excluding image data corresponding to an absence of growing crops.

FIG. 18 is a block diagram illustrating example operations to generate a resampled spectral index data map based on portions of received image data that correspond to growing crops and excluding portions of the image data that correspond to an absence of the growing crops.

FIG. 19 is a block diagram illustrating example operations to generate a normalized spectral index data map.

FIG. 20 is a screenshot of a nitrogen application plan graphically overlaid with an image of a region of interest.

FIG. 21 is a flow diagram illustrating example operations to determine a nitrogen stress status of growing crops within a region of interest based on one or more portions of image data that correspond to the growing crops and excluding one or more portions of the image data that correspond to an absence of the growing crops.

### DETAILED DESCRIPTION

According to techniques of this disclosure, a computing device can determine a nitrogen stress status of growing crops (e.g., corn, wheat, potatoes, or other types of crops) based on received image data, such as by determining a Medium Resolution Imaging Spectrometer (MERIS) Terrestrial Chlorophyll Index (MTCI) value that correlates to a nitrogen content (or deficiency) of the growing crops. As described herein, rather than determine the MTCI value based on image data that includes both crop and non-crop (e.g., soil) portions, a computing device implementing techniques of this disclosure can determine the MTCI value (which correlates to nitrogen level, or conversely, nitrogen deficiencies that can result in crop stress) based on portions of the image data that correspond to the growing crops and excluding portions of the image data that correspond to an absence of the growing crops (e.g., soil). In this way, techniques of this disclosure can enable more accurate determinations of crop nitrogen stress, particularly at low levels of nitrogen stress. Moreover, the techniques can enable the use of MTCI values, which are sensitive to low levels of nitrogen stress, to be effectively used in large-scale agricultural environments via image data of fields of crops.

As an example, corn maturation and development stages can be broken into two main categories: vegetative stages and reproductive stages. Vegetative stages begin with plant emergence from the soil (VE) and proceed through the development of each additional leaf (V1-V10+) and ultimately tasseling (VT). Following this, the corn plant switches to reproductive stages that include the corn plant silking (R1) through the complete maturation of the corn ear (R6). Generally, crop nitrogen uptake is low during the early stages of its vegetative growth, but as corn matures past the sixleaf stage (V6) and approaches tasseling (VT), nitrogen uptake increases substantially to satisfy the crop's nitrogen requirement for maximum grain yield potential. To minimize the impact of nitrogen deficiency on yield, it is common practice to over-apply nitrogen prior to V6 in an attempt to reduce the chance of a crop facing nitrogen deficiency. However, over-applying nitrogen in anticipation of the plant's future agronomic needs can lead to excessive loss of nitrogen, which is economically wasteful and potentially harmful to the environment.

Techniques such as tissue analysis and soil testing can be used to estimate nitrogen levels of crops. However, such techniques are time and resource intensive. Moreover, such techniques provide, at best, a random sampling of data across a field, thereby requiring extrapolation of the data and possible resulting inaccuracies. Spectral imaging techniques have been explored to determine nitrogen levels (or conversely, nitrogen deficiencies resulting in stress) of crops via image data of the field of crops. It is well-established that the color of a corn plant, for example, is sensitive to its nitrogen status. Therefore, through the “greenness” of the corn plant, it is possible to determine the amount of nitrogen within the plant.

One known method of determining relative variability of crop nitrogen uptake across a field includes the use of the Normalized Difference Vegetation Index (NDVI). The NDVI method, based on reflectance data of the crops at both a wavelength in the near infrared region and a red region of the electromagnetic spectrum, provides a resulting index that correlates to nitrogen content in vegetation (e.g., corn). However, NDVI values, when plotted against crop nitrogen levels, saturate toward the upper regions of the nitrogen levels that correspond to low (or zero) nitrogen stress levels. That is, the rate of change of NDVI values is low at nitrogen levels that correlate to low stress (higher levels of nitrogen), resulting in low sensitivity to low-stress crop conditions. As such, it can be difficult to accurately determine (or predict) a nitrogen stress status (i.e., nitrogen deficiency) of crops at early stages of crop development when nitrogen fertilizer has likely been applied in excess and the crops have yet to reach the development stage in which maximum nitrogen uptake occurs. Accordingly, using NDVI values, nitrogen stress is often detected in later stages of development after the stress has already affected the crop growth and potential yield.

MTCI values, which are based on reflectance data of crops in three narrowband regions, namely a near infrared region, a red edge region, and a red region of the electromagnetic spectrum, are more sensitive in regions of low nitrogen crop stress than are NDVI values. That is, the rate of change of MTCI values is greater than the rate of change of NDVI values at higher nitrogen levels which correlate to low nitrogen stress values. However, large-scale use (e.g., agricultural use) of MTCI values has been limited, in part, because of unreliable results prior to canopy closure of the crop. For instance, reflectance values of soil, which is present in image data of a field of crops during early stages of crop development prior to canopy closure, results in MTCI values which correlate to low nitrogen stress levels of the crops. As such, image data that includes reflectance values of soil as well as reflectance data of the crops can skew the resulting MTCI values toward low-stress indications, thereby providing unreliable indications of nitrogen stress levels of the crops.

Techniques of this disclosure can enable a computing device to utilize MTCI values to accurately determine a nitrogen stress status of growing crops during early stages of crop development and prior to canopy closure (i.e., when a canopy of vegetation obscures the ground as viewed from above). As described herein, the computing device can determine the MTCI values (or any spectral index values) of growing crops based on image data that corresponds to the growing crops and excluding image data the corresponds to an absence of the growing crops (e.g., soil, ground cover, debris, or other non-crop portions). In this way, the computing device can accurately determine a nitrogen stress status of the growing crops during early stages of crop development when reparative action, such as in-season nitrogen fertilizer application, has more time within the growing cycle to affect crop development and resulting yield (as compared with later stages of crop development). Moreover, the techniques can enable, through normalization techniques, the determination and comparison of a nitrogen stress status among multiple portions of a field, such as portions that include different hybrids of a crop or different types of crops. Accordingly, techniques of this disclosure enhance the field of spectral imaging techniques to ascertain nitrogen levels (or a nitrogen stress status) of growing crops, thereby helping to increase crop yield while decreasing both a cost of nitrogen fertilizer application and the possible negative environmental impacts associated with current fertilizer application techniques.

In some examples, and as described herein, a computing device can dynamically analyze various forms of data associated with agricultural crops of corn to determine the status of nitrogen in a plant, determine the quantity of nitrogen required for that plant, predict the quantity of nitrogen that will be required into the future, and issue notifications to the farmer regarding the timing, amount, and location of appropriate nitrogen applications. For instance, a computing device implementing techniques of this disclosure can receive data of various types from multiple sources, such as spectral data from a camera or other image sensor, weather data from one or more data feeds (e.g., public and/or private data sources), data entered via a user interface communicatively coupled to the computing device, or other types of data. The computing device can analyze the received data to determine current or future nitrogen status of growing corn within a region of interest (e.g., a field or portion of a field of crops), and can automatically provide one or more alerts or notifications (e.g., email, SMS message, voice message, alerts provided via a graphical user interface, or other types of alerts) in response to determining that the nitrogen status reflects nonconformance with acceptable corn growth and development criteria. In this manner, a computing device implementing techniques of this disclosure can provide timely and even predictive alerts of nitrogen deficiency in corn to interested parties, such as farmers, sales organizations, consultants and advisors to farmers, insurance carriers, buyers of agricultural products, agricultural landlords, bankers, and the like. Moreover, techniques described herein can improve the accuracy and efficiency of nitrogen application to corn. Accordingly, the computing device can enable such parties to take corrective action to minimize the likelihood of both yield loss and environmental nitrogen loss.

While described herein with respect to determining a current or predictive nitrogen status of growing crops of corn within a region of interest, techniques of this disclosure are not so limited. For instance, in certain examples, rather than determine a nitrogen status, a computing device implementing techniques of this disclosure can determine a growth status. Such growth status and/or loss status can be referred to as an agronomic status. Similarly, while the techniques are described herein with respect to a status of growing crops of corn, in certain examples, a computing device as described in this disclosure can determine an agronomic status for any growing biological matter. Accordingly, while described with respect to nitrogen deficiency analysis, the techniques described herein can, in certain examples, be applied to determine one or more of a loss and growth status of biological matter (e.g., including growing crops, such as agricultural crops) within a region of interest.

An agricultural crop can be subjected to multiple types of impactful factors, which can impact the nitrogen status of the growing crop. An inappropriate amount of available soil nitrogen can negatively affect the quality and/or quantity of resulting yield, which will therefore reduce the income received by the person managing the crop. In addition, losses of nitrogen from the crop rooting zone can negatively impact the surrounding environment. A computing device implementing techniques described herein can help to improve the efficiency and precision by which current nitrogen deficiency in corn is determined and future nitrogen deficiency in corn is predicted. For example, according to techniques of this disclosure, a computing device can receive data (e.g., spectral data) for a specific region of interest (e.g., a crop field) from a device passing across a field (e.g., an unmanned aerial vehicle (UAV), a satellite, irrigation equipment) equipped with a sensor (e.g., an active or passive radiometer, a camera, or a specially designed spectral imager), and use spectral analysis, computer vision, and analytic techniques to analyze the data. In addition to using field-passing devices to capture data, sometimes multiple times over the crop cycle, the computing device may receive and analyze data from multiple other sources, alone or in combination, to create a more meaningful, precise, and accurate nitrogen status assessment. Examples of such data can include, but are not limited to, weather data, modeling data, geographic information systems (GIS) data, planting equipment data, other farm implement equipment-generated data, and manually ascertained data, such as soil and tissue analysis. By analyzing multiple types of data received from multiple sources, a computing device implementing techniques described herein can increase the accuracy of nitrogen status and forecast nitrogen requirements.

For example, a nitrogen status determination and alert system implementing techniques of this disclosure can receive multiple types of data from multiple different sources, including in-season data related to agricultural crops within a region of interest (e.g., a crop field). The nitrogen status determination and alert system can dynamically analyze the data to determine the scope, extent, and specific location of current and future nitrogen deficiencies in a corn crop, document (e.g., store) the current and future nitrogen status, and automatically generate notifications and other relevant information concerning that nitrogen status. In some examples, the nitrogen status determination and alert system can include a user interface, data feeds, data sources, a communication network, a nitrogen status determination generator (NSDG), a nitrogen status prediction generator (NSPG) (together herein referred to as NSG), a database, or one or more other components.

The NSG can receive data for the region of interest from a variety of sources, such as from one or more of a user interface, a database, a data feed, an Internet-based data source, a remote sensor (e.g., a UAV, a satellite, irrigation equipment, or other device passing across a crop or field), a social network, and equipment used by farmers. In some examples, the NSG can receive such data via a communication network, such as the Internet, a cloud computing network, a cellular network, a local area network (LAN), a wide area network (WAN), a wireless LAN (WLAN), or other types of networks.

The user interface, executable by a computing device, can be configured to receive alerts, analyses, and statuses from the NSG via the communication network. In addition, the user interface can enable a user to interact with the nitrogen status determination and alert system. For instance, the user interface can be configured to receive information regarding manually ascertained data, such as data manually ascertained by a user and manually input to the user interface, and to provide such data to the NSG. Similarly, the user interface can be configured to receive an indication of the current and/or future nitrogen status from the NSG and output such statuses, such as to a user, to one or more computing devices, etc.

In some examples, the nitrogen status determination and alert system can include a database that is configured to store nitrogen status information. The database can be communicatively coupled to the NSG. The NSG can receive data from the database, analyze the received data, and determine a current and/or future nitrogen status for a region of interest (e.g., a field, a portion of a field, and the like).

The NSG can be configured to determine the scope and extent of nitrogen deficiency for the region of interest based at least in part on the received data. For example, the NSG can determine the scope, extent, and location of current and/or future nitrogen deficiency within the region of interest based at least in part on spectral data for the region of interest. One method of image analysis the technique known as computer vision. The spectral data that is acquired herein can be used to identify classifications within vegetative growth status. It is based on spectral analysis and processing and pattern recognition. With the use of computer vision, spectral data in the form of, for example, reflection data, pattern data, color data, texture data, shape data, shadow data, visible and/or non-visible light spectrum data, chemical image data, hyperspectral image data, and/or electronically modified (e.g., enhanced) image data for the region of interest, can be classified as possessing a particular nitrogen status. Additionally, computer vision, with predictive nitrogen status mathematical modeling, can determine a future nitrogen status. Another method by which the NSG can determine the scope, extent, and location of current and/or future nitrogen deficiency within the region of interest is known as spectral analysis. Spectral analysis includes statistics and signal processing; an algorithmic method that estimates the strength of different frequency components of a signal. A variety of vegetation indices are used to measure and analyze the different frequencies. Example indices include NDVI (normalized difference vegetation index), as well as other, less utilized indices in agriculture including the greenness index, NDNI (normalized difference nitrogen index), and other indices including proprietary and/or non-proprietary indices. The indices are generally used to determine the nitrogen status of a region of a field relative to another region. Because of factors that affect reflectance values when acquiring imagery (e.g., incoming sunlight, cloud cover, atmospheric scattering, etc.), spectral indices do not generally determine the absolute status of crop nitrogen.

In some examples, the NSG can receive one or more other types of data, such as one or more of field data (e.g., soil types and textures), topography data, weather data, planting equipment data, seed performance data, and data from other farmers through what may be described as a social network. The NSG can use one or more of the received data to determine the scope and extent of the nitrogen deficiency. In this way, the NSG can determine current and future nitrogen status to enable a user (e.g., a farmer or representative of the farmer) to properly understand the extent and scope of the nitrogen deficiency and establish the appropriate reparative actions. The NSG can determine a current or future nitrogen status with respect to an entire agricultural field or a portion of the field. In some examples, the NSG can determine whether the nitrogen status reflects conformance with acceptable nitrogen deficiency criteria, such as a percentage of nitrogen content or, conversely, a percentage of nitrogen deficiency. In certain examples, in response to determining that the nitrogen status reflects nonconformance with acceptable nitrogen deficiency criteria, the NSG can output at least one alert. In some examples, in response to determining that the nitrogen status does not reflect nonconformance with acceptable nitrogen deficiency criteria (i.e., reflects conformance with the acceptable nitrogen deficiency criteria), the NSG can refrain from outputting an alert.

Examples of users of the nitrogen status determination system can include, but are not limited to, farmers, sales organizations servicing the farmer, crop consultants, agronomists, representatives from a crop insurance carrier, buyers of agricultural products, agricultural landlords and/or bankers, or other persons who have a vested interest and/or responsibility in the growth and outcomes of an agricultural crop. Data incorporated into the nitrogen status determination and alert system can be received and/or derived from various sources, such as, but not limited to, a user via a user interface, planting equipment, other farm implement equipment, remote sensors (e.g., a UAV or other device traversing the field), Internet-based data sources, other farmers, and/or commercial, governmental, and/or public data sources. Similarly, data incorporated into the nitrogen status determination and alert system can include various types of data, such as field data (e.g., soil characteristics), weather data, climate data, terrain data (e.g., elevation and/or slope data), agronomic data (e.g., seed genetic data, seed performance characteristics data, plant research data, plant performance data, and the like). As another example, data incorporated into the nitrogen status determination and alert system can include image data, computer vision data, and/or spectral analysis data based on, for example, spectral reflectance response characteristics of plants and/or vegetation indices (algorithms used to measure the status of a plant) of corn plants in various stages of nitrogen status. For instance, the NSG can receive spectral wavelength data for growing crops within the region of interest and can compare the received spectral wavelength data or index to one or more optical signatures that indicate various stages of nitrogen deficiency. Optical signatures can be defined as the identified spectral wavelength reflectance characteristics that are associated with a plant that is experiencing particular conditions (i.e., a corn plant, in a particular growth stage, in a particular location, and subjected to particular impactful factors).

In some examples, the NSG can determine an attribute of received data and can include the received data into a corresponding attribute of the database. For instance, in examples where an attribute of the received data relates to the condition of the field, the NSG can incorporate the received data having the attribute that relates to the condition of the field into a corresponding field condition attribute of the database.

In certain examples, the user interface can receive configuration data (e.g., from a user) that configures (e.g., according to user preferences) how the NSG receives and analyzes data, the parameters around how and when the system notifies the user or other designated parties of nitrogen deficiency in the corn crop, any exclusions that the user desires to be exempt from the analyzed data, the manner and method by which the user, and/or other designated parties, are to be alerted, and the units of measurement in which the user would like to receive alerts having associated quantitative data. The NSG can output alerts, which can be received by a user and/or other designated parties via the communication network and the user interface. Examples of such alerts can include text messages, phone messages, voicemail messages, emails, or other types of alerts. In certain examples, an alert can include information such as maps to specify the location, size and shape of the area where the nitrogen deficiency has been determined and/or predicted, and/or an indication that the nitrogen status does not satisfy (e.g., falls outside) the acceptable nitrogen deficiency criteria. In some examples, the alert can include a visual analysis in the form of a chart or graph displaying determinations, locations, and comparative or benchmark data. In other examples, the output may be a file with instructions for a piece of equipment to apply nitrogen where needed and at the rate needed.

The NSG can receive configuration data (e.g., via the user interface, a file upload, and the like) that specifies data display preferences that can enable a more nuanced view of the nitrogen status determination data. For instance, a data display configuration parameter can exclude geographic areas within a region of interest that are not included within the nitrogen status determination area. Such exclusionary configuration parameters can enable a user to remove from consideration data and/or areas of a field that are physically incongruent with the rest of the field (e.g., ditches, rock piles, former building sites, etc.) and that would therefore skew or distort the overall dataset and the resulting determinations. If, in this example, the NSG receives configuration data (e.g., from a user via a user interface) that specifies an exclusionary zone within the region of interest due to, for example, information known by the user at the local level, such as the presence of a former building site or a prior manure or fertilizer spill, the NSG can exclude the region defined by the exclusionary zone from the region of interest and hence from the nitrogen status determination analysis.

The nitrogen status determination and alert system can receive data over a time period (e.g., a growing season, multiple years, or other time periods) and output a comparison of received data of the same crop in the same field over the time period. Likewise, predictive nitrogen status determination can take into account the nitrogen statuses of prior time periods to aid in predictive accuracy. Through the use of social networks, peer users may compare their nitrogen status with others, including those other users who have crops in relative proximity, and therefore are subject to similar environmental conditions (soil types, climate, weather, seed varieties, pests, etc.). In some examples, the user interface can be configured to output underlying data for display, such that a user may be able to personally view the underlying data. The NSG can output alerts other interested parties, as designated by configuration parameters defined by, for example, a user via the user interface. Such alerts can help to keep suppliers, buyers, landlords, and others abreast of the in-season corn crop growth and nitrogen status.

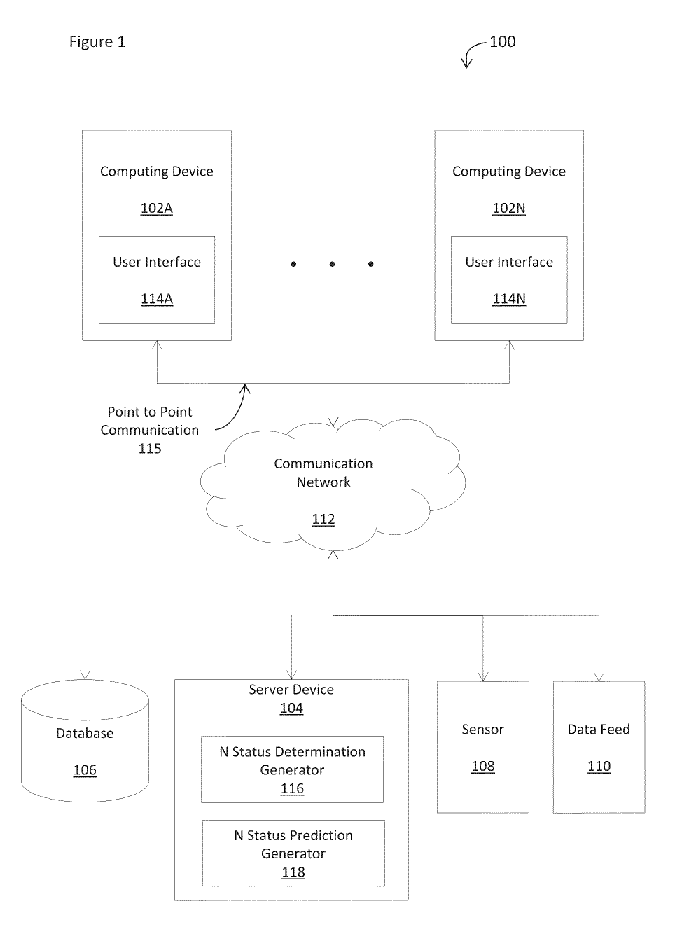

FIG. 1 is a block diagram illustrating an example nitrogen status determination and alert system 100, in accordance with one or more aspects of this disclosure. As illustrated in FIG. 1, nitrogen status determination and alert system 100 can include computing devices 102A-102N (collectively referred to herein as “computing devices 102”), server device 104, database 106, sensor 108, data feed 110, and communication network 112. Each of computing devices 102 can include a user interface, illustrated in FIG. 1 as user interfaces 114A-114N, and collectively referred to herein as “user interfaces 114.” Server device 104 can include Nitrogen Status Determination Generator (NSDG) 116 and Nitrogen Status Prediction Generator (NSPG) 118.

While illustrated with respect to computing devices 102A-102N, computing devices 102 can include any number of computing devices, such as one computing device 102, two computing devices 102, five computing devices 102, fifty computing devices 102, or other numbers of computing devices 102. Examples of computing devices 102 can include, but are not limited to, portable or mobile devices such as mobile phones (including smartphones), laptop computers, tablet computers, desktop computers, personal digital assistants (PDAs), servers, mainframes, or other computing devices.

Computing devices 102, in certain examples, can include user interfaces 114. For example, computing device 102A can include user interface 114A, executable by one or more processors of computing device 102A, that can enable a user to interact with computing device 102A and nitrogen status determination and alert system 100 via one or more input devices of computing device 102A (e.g., a keyboard, a mouse, a microphone, a camera device, a presence-sensitive and/or touch-sensitive display, or one or more other input devices). User interfaces 114 can be configured to receive input (e.g., in the form of user input, a document or file, or other types of input) and provide an indication of the received input to one or more components of nitrogen status determination and alert system 100 via communication network 112.

As illustrated in the example of FIG. 1, communication network 112 communicatively couples components of nitrogen status determination and alert system 100. Examples of communication network 112 can include wired or wireless networks or both, such as local area networks (LANs), wireless local area networks (WLANs), cellular networks, wide area networks (WANs) such as the Internet, or other types of networks. Although the example of FIG. 1 is illustrated as including one communication network 112, in certain examples, communication network 112 may include multiple communication networks. In addition, as illustrated in FIG. 1, one or more of computing devices 102 can communicate with one another via point-to-point communications 115.

Database 106 can include one or more databases configured to store data related to nitrogen status determination and prediction. For instance, database 106 can include one or more relational databases, hierarchical databases, object-oriented databases, multi-dimensional databases, or other types of databases configured to store data usable by nitrogen status determination and alert system 100 to determine a current or future nitrogen status of growing crops within a region of interest. As an example, and as further described herein, database 106 can include one or more databases configured to store field data, production data, weather data, manually ascertained data, agronomic data, geographic data, crop data, farm equipment data, configuration data, optical signature data, or other types of data that are retrievable by NSDG 116 and NSPG 118 to determine a current or future nitrogen status.

Sensor 108 can include one or more sensors capable of gathering data usable by nitrogen status determination and alert system 100. For instance, sensor 108 can include one or more of a remote sensor (e.g., a sensor that is physically remote from the region of interest) and an in-field sensor (e.g., a sensor that is physically proximate and/or within the region of interest). As one example, sensor 108 can include an active sensor (i.e., provides its own energy source for illumination) or passive sensor (i.e., uses an external energy source such as sunlight for illumination), such as a sensor included within a radiometer, a camera device (e.g., a visible-spectrum image sensor, an ultra-violet (UV) image sensor, an infra-red image sensor such as included in a thermal imaging camera, a multispectral image sensor, a narrowband spectral image sensor, a hyperspectral image sensor, or other types of image sensors) and be configured to gather spectral and/or image data for a region of interest, such as a field of growing crops. Such spectral and/or image data can include, but is not limited to, reflectance data, vegetation indices, optical signature image data, crop color data (e.g., traditional, red, infrared, green, blue), pattern data, tone data, texture data, shape data, and shadow data.

In certain examples, sensor 108 can include one or more other sensors, such as precipitation sensors (e.g., a rain gauge), light sensors, wind sensors, or other types of sensors. In some examples, sensor 108 can include one or more remote sensors carried by, for example, an unmanned aerial vehicle (UAV), an aircraft, a satellite, irrigation equipment, a device passing across (i.e., traversing) the field, and the like. For instance, sensor 108 may include one or more image sensors included within a camera device carried by a UAV and configured to capture spectral data for a region of interest (e.g., a field, a portion of a field, a region including a field and its surrounding area, and the like). Such UAVs can be convenient vehicles for obtaining in-season data related to crop condition due in part to their ability to gather data in a timely, quick, scalable, and economical manner. In other instances, sensor 108 can include one or more sensors location on or in the ground.

As illustrated in FIG. 1, one or more components of nitrogen status determination and alert system 100 can be configured to receive data from data feed 110 (e.g., via communication network 112, point-to-point communications 115, peer-to-peer communication, etc.). Examples of data received by components of nitrogen status determination and alert system 100 from data feed 110 can include vegetation data, weather data (e.g., temperature data, historical temperature data, data indicating events such as thunderstorms, floods, hail, wind storms, etc.), climate data, or other types of data. Data feed 115 may provide data to components of nitrogen status determination and alert system 100 via various sources, such as commercial, governmental, public and/or fee-based data sources. For instance, such sources can include Internet-based sources, such as the United States Department of Agriculture, the National Oceanic and Atmospheric Administration, or other public and/or private data sources. As another example, data feed 110 can provide data to components of nitrogen status determination and alert system 100 from sources such as combines, planters, sprayers, cultivators, and other equipment used to execute various agricultural practices or tasks, as well as academic and/or research organizations, suppliers of crop inputs, buyers of crops, and peer farmers. In some examples, data feed 110 can provide information obtained from a social networking service, such that data feed 110 can provide components of nitrogen status determination and alert system 100 with information obtained from peer farmers and/or other computing systems.

As illustrated in the example of FIG. 1, nitrogen status determination and alert system 100 can include server device 104. In certain examples, server device 104 can be substantially similar to computing devices 102, in that server device 104 can be a computing device including one or more processors capable of executing computer-readable instructions stored within memory of server device 104 that, when executed, cause server device 104 to implement functionality according to techniques described herein. For instance, server device 104 can be a portable or non-portable computing device, such as a server computer, a mainframe computer, a desktop computer, a laptop computer, a tablet computer, a smartphone, a computing device carried via the field-passing device, or other type of computing device. In some examples, although illustrated in FIG. 1 as including one server device 104, nitrogen status determination and alert system 100 can include multiple server devices 104. For instance, in certain examples, nitrogen status determination and alert system 100 can include multiple server devices 104 that distribute functionality attributed to server device 104 among the multiple server devices.

As illustrated, server device 104 can include NSDG 116 and NSPG 118. NSDG 116 can include any combination of software and/or hardware executable by one or more server devices 104 to determine a growth status and/or a nitrogen status according to techniques described herein. NSPG 118 can also include any combination of software and/or hardware executable by one or more server devices 104 to predict a growth status and/or a future nitrogen status according to techniques described herein. Any one or more functionalities can be performed by either module (i.e., NSDG 116 and NSPG 118), but for the purposes of this disclosure, NSPG 118 can adopt the results performed by NSDG 116 in order to perform further predictive computations.

As an example, NSDG 116 and NSPG 118 can receive data for a region of interest that includes growing corn crops. For instance, NSDG 116 and NSPG 118 can receive data from one or more of computing devices 102 (e.g., via user interfaces 114), database 106, sensor 108, and data feed 110 via communication network 112, point-to-point communications 115, and the like. Further, NSPG 118 can receive data for a region of interest from NSDG 116. The received data can include data usable by NSDG 116 and NSPG 118 to determine a current and/or future nitrogen status of growing crops within the region of interest. For example, NSDG 116 and NSPG 118 can receive one or more of field data, production data, weather data, manually ascertained data, geographic data, crop data, farm equipment data, configuration data, optical signature data, or other types of data.

In some examples, NSDG 116 can receive image data for a region of interest that includes growing crops. NSDG 116 can identify one or more portions of the image data that correspond to the growing crops and one or more portions of the image data that correspond to an absence of the growing crops. For instance, NSDG 116 can determine NDVI values corresponding to each of multiple portions of the image data (e.g., individual pixels of the image data or aggregations of pixels) and can classify each portion as corresponding to growing crops or the absence of growing crops based on the determined NDVI value, as is further described below.

NSDG 116 can determine, based on the one or more portions of the image data that correspond to the growing crops and excluding the one or more portions of the image data that correspond to the absence of the growing crops, a nitrogen stress status (e.g., an indication of nitrogen deficiency) of the growing crops within the region of interest. For example, NSDG 116 can determine spectral index values (e.g., MTCI values, NDVI values, NDNI values, or other spectral index values) for each portion of the image data to create a spectral index map that correlates spectral index values for each portion of the image data with a geographical portion or the region of interest corresponding to the portion of the image data. NSDG 116 can resample, in certain examples, the spectral index map to create a resampled (e.g., averaged) spectral image map that relates to the entire region of interest and is based on spectral index values for each portion of the image data that corresponds to the growing crops and excluding spectral index values for each portion of the image data that corresponds to the absence of the growing crops, as is further described below.

NSDG 116 can determine, based on the resampled spectral image map (which is, in turn, based on spectral index values corresponding to growing crops and excluding spectral index values corresponding to an absence of growing crops), a nitrogen stress status of the growing crops within the region of interest. For instance, NSDG 116 can compare a nitrogen stress status (e.g., a percentage of nitrogen content of the growing crops, a percentage of nitrogen deficiency of the growing crops, or other indications of nitrogen stress) of the growing crops with one or more benchmark criteria, such as a threshold percentage of acceptable nitrogen content. In certain examples, NSDG 116 can determine a separate nitrogen stress status for each of multiple portions of the region of interest, such as portions segregated into square inches, square feet, linear inches and/or feet of rows, or other segregated portions of the region of interest. NSDG 116 can generate a nitrogen application plan, based on the determined nitrogen stress status(es), the nitrogen application plan indicated one or more nitrogen-stressed areas of the region of interest at which nitrogen is to be applied and one or more areas of the region of interest at which nitrogen is not to be applied (e.g., nitrogen-sufficient areas). Nitrogen fertilizer can thereafter be applied to the region of interest according to the nitrogen application plan. That is, nitrogen fertilizer can be applied to those areas of the region of interest indicated as nitrogen-stressed but not to those areas of the region of interest indicated as nitrogen-sufficient by the nitrogen application plan.

In this way, techniques of this disclosure can enable determination of a nitrogen stress status of growing crops within the region of interest based on image data corresponding to the growing crops and excluding image data corresponding to an absence of growing crops. Accordingly, the techniques can enable accurate determination of nitrogen stress among the growing crops, as well as specific ones or areas of the growing crops experiencing the stress, during early stages of crop development (i.e., prior to canopy closure) when non-crop (e.g., soil) reflectance data is likely to be included in the image data.

In some examples, NSDG 116 can determine, based at least in part on the received data for the region of interest, that a nitrogen status of the growing crops within the region of interest reflects nonconformance with acceptable nitrogen deficiency criteria. As an example, NSDG 116 can determine, based on one or more of the received data, that a nitrogen status falls outside a range of acceptable nitrogen deficiency criteria, such as a range of percentages of nitrogen deficiency, a range of areas of the region of interest in which nitrogen deficiency is determined, and the like. In certain examples, NSDG 116 can determine that the nitrogen status of the growing crops within the region of interest reflects nonconformance with acceptable nitrogen deficiency criteria based on a determination, by NSDG 116, that the received data does not satisfy one or more parameters (e.g., is greater than the one or more parameters, greater than or equal to the one or more parameters, falls outside a range of one or more parameters, and the like).

In some examples, rather than determine a nitrogen status, NSDG 116 can determine a growth status of biological matter (e.g., including growing crops) within a region of interest. In such examples, NSDG 116 can be referred to as a field growth determination generator. Such a field growth determination generator can determine an agronomic status (e.g., a loss and/or growth status) of biological matter within a region of interest.

A nitrogen status can include an indication of at least one of an extent of nitrogen deficiency (e.g., an indication of a severity of nitrogen deficiency, such as a percentage of nitrogen deficiency), a scope of nitrogen deficiency (e.g., an indication of an area of the region of interest in which nitrogen deficiency is determined, such as a number of acres), and a location of nitrogen deficiency of the growing crops within the region of interest. In response to determining that the nitrogen status reflects nonconformance with the acceptable nitrogen deficiency criteria, NSDG 116 can output at least one alert. Similarly, NSDG 116 can output a prescheduled and recurring notification that informs the recipient of the nitrogen status, regardless of whether or not it is found to be deficient. For instance, NSDG 116 can output the at least one alert including one or more email messages, short messaging service (SMS) messages, voice messages, voicemail messages, audible messages, or other types of messages that include an indication of the at least one alert. In certain examples, NSDG 116 can output an alert to user interfaces 114 (e.g., via communication network 112). In some examples, NSDG 116 can determine a distribution list, such as a list of accounts associated with nitrogen status determination and alert system 100 (e.g., user accounts, accounts associated with one or more other computing systems, etc.), and can output the at least one alert to the list of accounts.

NSPG 118 can determine, based at least in part on the received data for the region of interest from NSDG 116, that a future nitrogen status of the growing crops within the region of interest reflects nonconformance with acceptable nitrogen deficiency criteria. As an example, NSPG 118 can determine, based on one or more of the received data, that a future nitrogen status falls outside a range of acceptable future nitrogen deficiency criteria, such as a range of percentages of future nitrogen deficiency, a range of areas of the region of interest in which future nitrogen deficiency is determined, and the like. In certain examples, NSPG 118 can determine that the future nitrogen status of the growing crops within the region of interest reflects nonconformance with acceptable future nitrogen deficiency criteria based on a determination, by NSPG 118, that the received data does not satisfy one or more parameters (e.g., is greater than the one or more parameters, greater than or equal to the one or more parameters, falls outside a range of one or more parameters, and the like).

In some examples, rather than determine a future nitrogen status, NSPG 118 can determine a future growth status of biological matter (e.g., including growing crops) within a region of interest. In such examples, NSPG 118 can be referred to as a future field growth determination generator. Such a future field growth determination generator can determine a future agronomic status (e.g., a loss and/or growth status) of biological matter within a region of interest.

A future nitrogen status can include an indication of at least one of an extent of future nitrogen deficiency (e.g., an indication of a severity of future nitrogen deficiency, such as a percentage of future nitrogen deficiency) and a scope of future nitrogen deficiency (e.g., an indication of an area of the region of interest in which future nitrogen deficiency is determined, such as a number of acres) of the growing crops within the region of interest. In response to determining that the future nitrogen status reflects nonconformance with the acceptable future nitrogen deficiency criteria, NSPG 118 can output at least one alert. Similarly, NSPG 118 can output a prescheduled and recurring notification that informs the recipient of the predictive nitrogen status, regardless of whether or not it is found to be deficient. For instance, NSPG 118 can output the at least one alert including one or more email messages, short messaging service (SMS) messages, voice messages, voicemail messages, audible messages, or other types of messages that include an indication of the at least one alert. In certain examples, NSPG 118 can output an alert to user interfaces 114 (e.g., via communication network 112). In some examples, NSPG 118 can determine a distribution list, such as a list of accounts associated with future nitrogen status determination and alert system 100 (e.g., user accounts, accounts associated with one or more other computing systems, etc.), and can output the at least one alert to the list of accounts.

In certain examples, nitrogen status determination and alert system 100 can include one or more components not illustrated in FIG. 1. For instance, as discussed above, nitrogen status determination and alert system 100 can include, in some examples, multiple server devices 104 that distribute functionality of server device 104 among the multiple server devices 104. Similarly, one or more illustrated components of nitrogen status determination and alert system 100 may not be present in each embodiment of nitrogen status determination and alert system 100. For instance, in certain examples, at least one computing devices 102 and server device 104 may comprise a common device. For example, server device 104 and computing device 102 can, in some examples, be one device that executes both NSDG 116 and NSPG 118, as well as user interface 114.

As one example operation of nitrogen status determination and alert system 100 of FIG. 1, NSDG 116, executing on one or more processors of server device 104, can receive data for a region of interest, such as a field of growing crops. For instance, NSDG 116 can receive, via communication network 112, the data for the region of interest from one or more of database 106, sensor 108, data feed 110, and computing devices 102 (e.g., via one or more of user interfaces 114). NSDG 116 can determine, based on the received data for the region of interest, that a nitrogen status of the growing crops within the region of interest reflects nonconformance with acceptable nitrogen deficiency criteria, such as criteria that define an acceptable severity and/or scope of nitrogen deficiency. NSDG 116 can output, in response to determining that the current nitrogen status reflects nonconformance with the acceptable nitrogen deficiency criteria, at least one alert. For instance, NSDG 116 can output one or more alerts or notifications to one or more of computing devices 102, such one or more alerts that are output to one or more of user interfaces 114, one or more email messages, voice messages, voicemail messages, text messages, SMS messages, or other types of alerts. In certain examples, the one or more alerts or notifications can include an indication of a degree by which the current nitrogen status of the growing crops within the region of interest deviates from the acceptable nitrogen deficiency criteria. In some examples, the one or more alerts can include an indication of the region of interest and/or a portion of the region of interest (e.g., a portion of the field) that reflects nonconformance with the acceptable nitrogen deficiency criteria. Likewise, NSPG 118 can receive, via communication network 112, the data for the region of interest from one or more of database 106, sensor 108, data feed 110, computing devices 102, and NSDG 116 (e.g., via one or more of user interfaces 114). NSPG 118 can determine, based on the received data for the region of interest, that a future nitrogen status of the growing crops within the region of interest reflects nonconformance with acceptable future nitrogen deficiency criteria, such as criteria that define an acceptable severity and/or scope of nitrogen deficiency. NSPG 118 can output, in response to determining that the future nitrogen status reflects nonconformance with the acceptable future nitrogen deficiency criteria, at least one alert. For instance, NSPG 118 can output one or more alerts to one or more of computing devices 102, such one or more alerts that are output to one or more of user interfaces 114, one or more email messages, voice messages, voicemail messages, text messages, SMS messages, or other types of alerts. In certain examples, the one or more alerts can include an indication of a degree by which the future nitrogen status of the growing crops within the region of interest deviates from the acceptable future nitrogen deficiency criteria. In some examples, the one or more alerts can include an indication of the region of interest and/or a portion of the region of interest (e.g., a portion of the field) that reflects nonconformance with the acceptable future nitrogen deficiency criteria.

In this way, NSDG 116 and NSPG 118 can dynamically analyze multiple forms of data received from multiple input sources to determine a current and/or future nitrogen status of growing crops within a region of interest. NSDG 116 and NSPG 118 can automatically output at least one alert in response to determining that the current and/or future nitrogen status reflects nonconformance with acceptable nitrogen deficiency criteria. Accordingly, NSDG 116 and NSPG 118 can output timely alerts regarding current and/or future nitrogen deficiency that may enable a user, such as a farmer, to take corrective action, such as by immediately applying or planning on a future date to apply nitrogen to one or more portions of a field, to help minimize the scope and extent of the current and/or future nitrogen deficiency. Moreover, by analyzing multiple forms of data, NSDG 116 and NSPG 118 can increase the accuracy of the determination of the current and/or future nitrogen status, thereby possibly enabling a more accurate nitrogen application treatment corresponding to the deficiency.

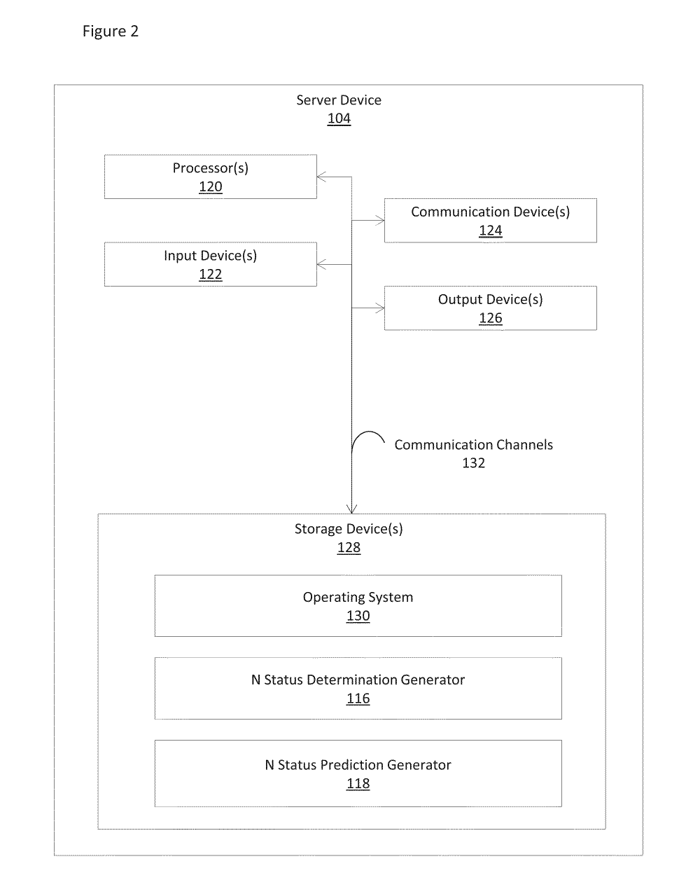

FIG. 2 is a block diagram illustrating further details of one example of server device 104 shown in FIG. 1, in accordance with one or more aspects of this disclosure. FIG. 2 illustrates only one example of server device 104, and many other examples of server device 104 can be used in other examples.

As shown in the example of FIG. 2, server device 104 can include one or more processors 120, one or more input devices 122, one or more communication devices 124, one or more output devices 126, and one or more storage devices 128. As illustrated, server device 104 can include operating system 130 and NSDG 116 that are executable by server device 104 (e.g., by one or more processors 120).

Each of components 120, 122, 124, 126, and 128 can be interconnected (physically, communicatively, and/or operatively) for inter-component communications. In some examples, communication channels 132 can include a system bus, a network connection, an inter-process communication data structure, or any other method for communicating data. As illustrated, components 120, 122, 124, 126, and 128 can be coupled by one or more communication channels 132. Operating system 130, NSDG 116, and NSPG 118 can also communicate information with one another as well as with other components of server device 104, such as output devices 126.

Processors 120, in one example, are configured to implement functionality and/or process instructions for execution within server device 104. For instance, processors 120 can be capable of processing instructions stored in storage device 128. Examples of processors 120 can include any one or more of a microprocessor, a controller, a digital signal processor (DSP), an application specific integrated circuit (ASIC), a field-programmable gate array (FPGA), or other equivalent discrete or integrated logic circuitry.

One or more storage devices 128 can be configured to store information within server device 104 during operation. Storage device 128, in some examples, is described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, storage device 128 is a temporary memory, meaning that a primary purpose of storage device 128 is not long-term storage. Storage device 128, in some examples, is described as a volatile memory, meaning that storage device 128 does not maintain stored contents when power to server device 104 is turned off. Examples of volatile memories can include random access memories (RAM), dynamic random access memories (DRAM), static random access memories (SRAM), and other forms of volatile memories. In some examples, storage device 128 is used to store program instructions for execution by processors 120. Storage device 128, in one example, is used by software or applications running on server device 104 (e.g., NSDG 116) to temporarily store information during program execution.

Storage devices 128, in some examples, also include one or more computer-readable storage media. Storage devices 128 can be configured to store larger amounts of information than volatile memory. Storage devices 128 can further be configured for long-term storage of information. In some examples, storage devices 128 include non-volatile storage elements. Examples of such non-volatile storage elements can include magnetic hard discs, optical discs, floppy discs, flash memories, or forms of electrically programmable memories (EPROM) or electrically erasable and programmable (EEPROM) memories.

Server device 104, in some examples, also includes one or more communication devices 124. Server device 104, in one example, utilizes communication device 124 to communicate with external devices via one or more networks, such as one or more wireless networks. Communication device 124 can be a network interface card, such as an Ethernet card, an optical transceiver, a radio frequency transceiver, or any other type of device that can send and receive information. Other examples of such network interfaces can include Bluetooth, 3G, 4G, and WiFi radio computing devices as well as Universal Serial Bus (USB). In some examples, server device 104 can utilize communication device 124 to wirelessly communicate with an external device, such as one or more sensors 108 (illustrated in FIG. 1).

Server device 104, in one example, also includes one or more input devices 122. Input device 122, in some examples, is configured to receive input from a user. Examples of input device 122 can include a mouse, a keyboard, a microphone, a camera device, a presence-sensitive and/or touch-sensitive display, or other type of device configured to receive input from a user.

One or more output devices 126 can be configured to provide output to a user. Examples of output device 126 can include, a display device, a sound card, a video graphics card, a speaker, a cathode ray tube (CRT) monitor, a liquid crystal display (LCD), or other type of device for outputting information in a form understandable to users or machines.

Server device 104 can include operating system 130. Operating system 130 can, in some examples, control the operation of components of server device 104. For examples, operating system 130, in one example, facilitates the communication of NSDG 116 and NSPG 118 with processors 120, input devices 122, communication devices 124, and/or output devices 126.

NSDG 116 and NSPG 118 can include program instructions and/or data that are executable by server device 104 to perform one or more of the operations and actions described in the present disclosure. For instance, NSDG 116 and NSPG 118 can receive data for a region of interest from one or more of communication devices 124 (e.g., from a remote device, such as from one or more of computing devices 102, sensor 108, data feed 110, and/or database 106) and input devices 122 (e.g., a mouse, keyboard, or other input devices). NSDG 116 and NSPG 118, executing on one or more processors 120, can determine, based on the received data for the region of interest, that a current or future nitrogen status of growing corn crops within the region of interest reflects nonconformance with acceptable current or future nitrogen deficiency criteria. For instance, NSDG 116 can determine the nitrogen status for the region of interest based on received data such as crop data, field data, production data, weather data, manually ascertained data, geographic data, farm equipment data, configuration data, optical signature data, or other types of data, as is further described herein. NSDG 116 can output, in response to determining that the nitrogen status reflects nonconformance with the acceptable nitrogen deficiency criteria, at least one alert. For instance, NSDG 116 can output at least one alert via one or more of output devices 126 (e.g., a displayed alert, an audible alert, or other types of alert) and communication devices 124 (e.g., via communication network 112 to computing devices 102). Likewise NSPG 118 can determine the future nitrogen status of growing corn crops for the region of interest based on received data such as crop data, field data, production data, weather data, manually ascertained data, geographic data, farm equipment data, configuration data, optical signature data, or other types of data, as is further described herein. NSPG 118 can output, in response to determining that the future nitrogen status reflects nonconformance with the acceptable future nitrogen deficiency criteria, at least one alert. For instance, NSPG 118 can output at least one alert via one or more of output devices 126 (e.g., a displayed alert, an audible alert, or other types of alert) and communication devices 124 (e.g., via communication network 112 to computing devices 102).

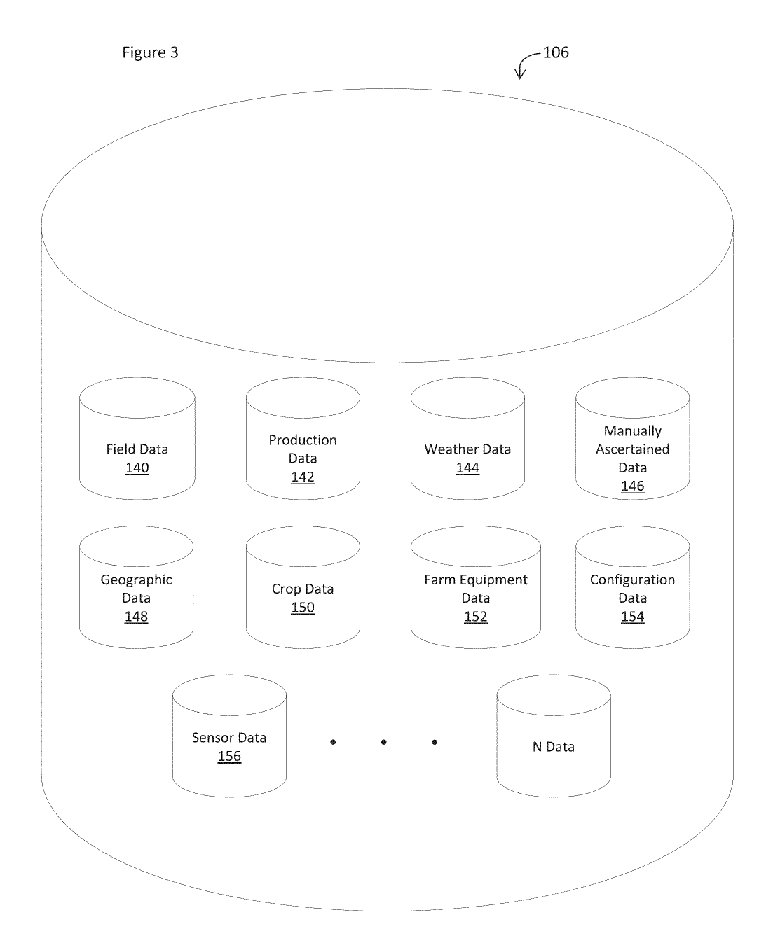

FIG. 3 is a block diagram illustrating further examples of database 106 illustrated in FIG. 1, in accordance with one or more aspects of this disclosure. As illustrated, database 106 can include field data 140, production data 142, weather data 144, manually ascertained data 146, geographic data 148, crop data 150, farm equipment data 152, configuration data 154, and sensor data 156. In some examples, as is illustrated in FIG. 3 by including “Nitrogen Data”, database 106 can include one or more types of data that are not illustrated in FIG. 3. That is, the illustration of element “Nitrogen Data” indicates that data included within database 106 is not limited to the illustrated categories, but may include one or more categories not illustrated in FIG. 3. Similarly, in certain examples, database 106 can include fewer data and/or data categories than are illustrated in FIG. 3. For instance, in some examples, database 106 can include one, two, three, five, or other numbers of data categories, and may not include each of the categories illustrated in FIG. 3. In certain examples, data can be present within database 106 in multiple forms and/or combinations. For instance, in some examples, data can be included in multiple categories of data. In some examples, data can be present within one or more of the categories and represented by multiple forms within the one or more categories.

Field data 140 can include data regarding, for example, field locations, the shape of the field, the proximity of the field to other relevant locations such as other fields managed and operated by the user. Field data 140 can, in certain examples, also include field data for the fields of other farmers (e.g., received via a social network or other such method), such as crop quality problems on a nearby field operated by another farmer. For instance, nitrogen deficiency on another nearby field can indicate a crop quality problem on its neighboring fields. In some examples, field data 140 can include data associated with characteristics of the field, such as topographical information, soil types, organic matter, residue, moisture condition and water-holding capacity, fertility, and other non-crop vegetation on the field. In certain examples, field data 140 can include data associated with previously performed analyses such as tissue and soil tests and determinations of nitrogen status over time.

Production data 142 can include data regarding, for example, crop production practices and/or events. For instance, production data 142 can include historical crop production data associated with a field, including data corresponding to crops planted in prior years, nitrogen application practices, including products and rates, and historical yields, including yield maps illustrating yield variability across the field, as-planted maps, and tile maps (e.g., maps indicating locations of drainage tiles installed in the field). As another example, production data 142 can include data associated with historical practices corresponding to a field, such as tillage and irrigation information. Similarly, production data 142 can include data regarding neighboring fields, such as production and/or historical information corresponding to regions physically proximate a region of interest (e.g., a field).

Weather data 144 can include data associated with weather data for a region, area, or field. Examples of such information can include, but is not limited to, rainfall data (e.g., average amounts of rainfall, total rainfall for a given period, deviation of precipitation from an average, and the like), hail data (e.g., information corresponding to a hail event, such as a time and location, a size of hail, etc.), temperature data (e.g., average temperatures, deviation of temperature from an average temperature, high temperature within a period of time, low temperature within a period of time, or other temperature data), wind data (e.g., wind speed data, average wind speed data, wind direction data, etc.), forecast data for any other above (e.g., rainfall, hail, temperature, wind, etc.) or other types of data. Weather data 144 can also include data associated with trends in weather and/or climate data for a region of interest over a period of time, such as over weeks, months, years, or other periods of time.

Manually ascertained data 146 can include data relating to knowledge specific to a user and may include, for example, site-specific knowledge, past experiences, activities, observations, and outcomes. For instance, manually ascertained data 146 can include data that is gathered by a user by walking through the crop or inspecting (viewing) crop. On some occasions, manually ascertained data 146 can be used (e.g., by NSDG 116 and/or NSPG 118) to override or modify an aspect of a nitrogen status determination analysis, such as by using manually ascertained data 146 rather than corresponding data collected from another source. In some examples, manually ascertained data can include data corresponding to a manual verification of the nitrogen status determination analysis, such as a manual verification following the issuance of an alert.

Geographic data 148 can include geographic data associated with, for example, the region of interest, such as fields included in the region of interest and included in the nitrogen status determination, analysis, and alerts. Examples of geographic data can include, but are not limited to, geographic data relating to roadways, surface and/or underground water, and landmark locations. Geographic data 148 can be gathered, such as from satellite images, global positioning information, historical information regarding an area of land, plat book service providers, non-governmental and governmental organizations, public and private organizations and agencies, or other sources.

Crop data 150 can include information associated with growing crops within a region of interest. For instance, crop data 150 can include data such as a type of seed planted, an average depth at which seeds are planted, a population of seeds planted (e.g., a population density), a time (e.g., a date) when seeds are planted, crop condition data, crop height data, crop color data, crop input data (e.g., types of and/or amounts of fertilizers and/or chemicals applied to the crops), Economic Optimum Nitrogen Rate (EONR), yield environment or yield estimation data, or other types of data associated with the growing crops within the region of interest. Crop data 150 can include data associated with crop conditions over a growing season, such as determined through various sensing methods (e.g., UAVs, in-field sensors, and the like).

Farm Equipment data 152 can include information associated with and gathered through the planting, tending, harvesting, crop handling, and storage of crops using equipment prior to, during, and/or following the growing season. Examples of farm equipment data may include, but are not limited to, seed location data, seed population data, chemical application quantity data, and crop harvesting data (e.g., from yield-monitors included in a combine harvester machine).

Configuration data 154 can include configuration data associated with the nitrogen status analysis. For instance, configuration data 154 can include one or more parameters which, if exceeded, can trigger NSDG 116 and/or NSPG 118 to output at least one alert. Example parameters can include a schedule, (e.g., each Monday), threshold value, a range of values, or other parameters that NSDG 116 and/or NSPG 118 can use to determine whether a current or future nitrogen status of growing crops within a region of interest reflects nonconformance with acceptable current or future nitrogen deficiency criteria. For instance, in examples where one or more of the parameters includes a threshold value, NSDG 116 and/or NSPG 118 can compare one or more of the received data for the region of interest with the threshold value, and can determine that the data satisfies the one or more parameters in response to determining that the data is less than the threshold value, less than or equal to the threshold value, greater than the threshold value, greater than or equal to the threshold value, or by other such comparisons. In examples where one or more of the parameters includes a range of values, NSDG 116 and/or NSPG 118 can compare one or more of the received data for the region of interest with the range of values, and can determine that the data satisfies the one or more parameters in response to determining that the data is within the range of values. Similarly, NSDG 116 and NSPG 118 can determine that the data does not satisfy the one or more parameters in response to determining that the data falls outside the range of values.

Sensor data 156 can include computer vision data, spectral reflectance data, and optical signature data. Spectral reflectance data at specific wavelengths has been determined to correlate with particular plant stressors under particular conditions, which when identified results in an optical signature. Vegetation indices (VIs), which are basic forms of optical signatures, are combinations of reflectance at two or more wavelengths designed to highlight a particular property of vegetation. Vegetation indices can determine variability across a region of interest, and can be used to accentuate the conditions of a crop, ranging from “perfect” plant health to diseased, infested, and/or malnourished plant health. Sensor data 156 can include vegetation indices, the reflectance at multitude and various hyperspectral or multispectral wavelengths of a plant, the resulting derivative reflectance from hyperspectral data, and the corresponding environment conditions that result in those reflectance, derivative, or index values. Once the sensor-captured data has been processed and matched to the library of known optical signatures, a nitrogen status can be identified. Crop and environmental conditions that can modify the sensor results include wind, moisture, corn hybrid planted, growth stage, time of day, incoming sunlight, spatial scale of the sensor, and latitude.

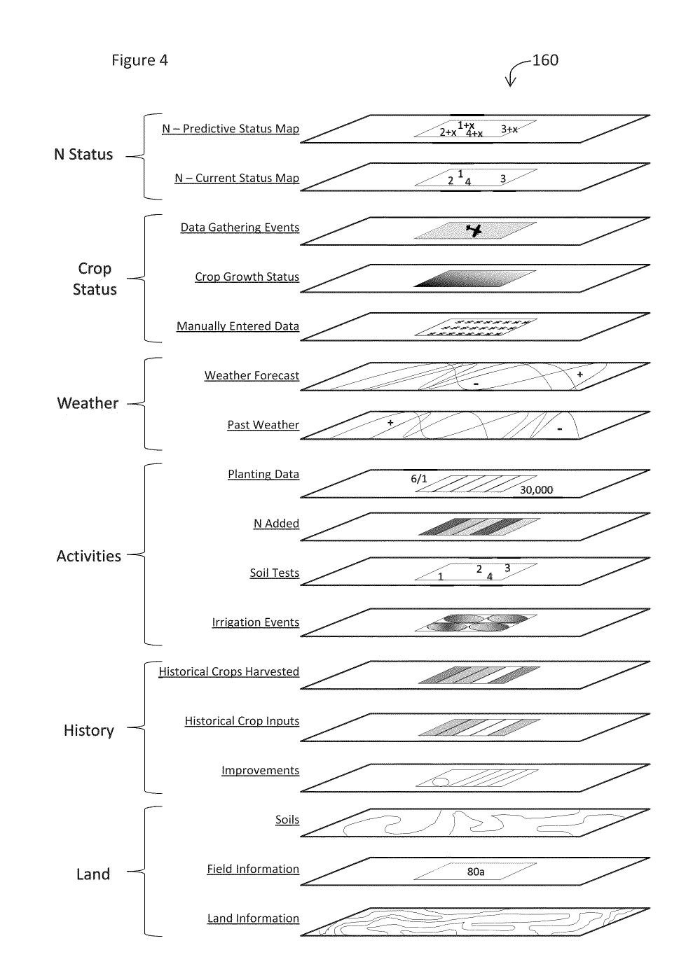

FIG. 4 illustrates an example geographic information system (GIS), in accordance with one or more aspects of this disclosure. As illustrated in FIG. 4, GIS layers image 160 includes multiple data structures, each of which can be regarded as a layer. Such layers can provide information regarding various data elements of a nitrogen status analysis and alert for a field, including, for example, land data, historical data, activities data, weather data, crop status data, and nitrogen status data.

Examples of land data can include data associated with an area of land (e.g., a field, a field and adjacent areas, and the like). Such data can include topography data, an indication of the presence of ground water, soil attributes (e.g., soil types, texture, organic matter, fertility test results, etc.), the location, size, and shape of the field, or other types of data. Examples of historical data can include the improvements made upon the field (i.e., tile, irrigation), the historical crop inputs (i.e., previously planted hybrids and previously applied nitrogen), and the historical crop harvested. Activities data can include irrigation events, soil tests, nitrogen added, and planting data (i.e., planted seed, planted population, etc.). Weather data can include historical and predicted weather and climate data. Crop status data can include manually entered data (i.e., the user manually entering data with regard to his or her observations, and/or neighboring farmers entering their observations about adjacent fields/areas), crop growth status data, and data gathering events, such as UAV flights or devices passing across the field. nitrogen status data can include a map for current nitrogen status and a map for future nitrogen status.

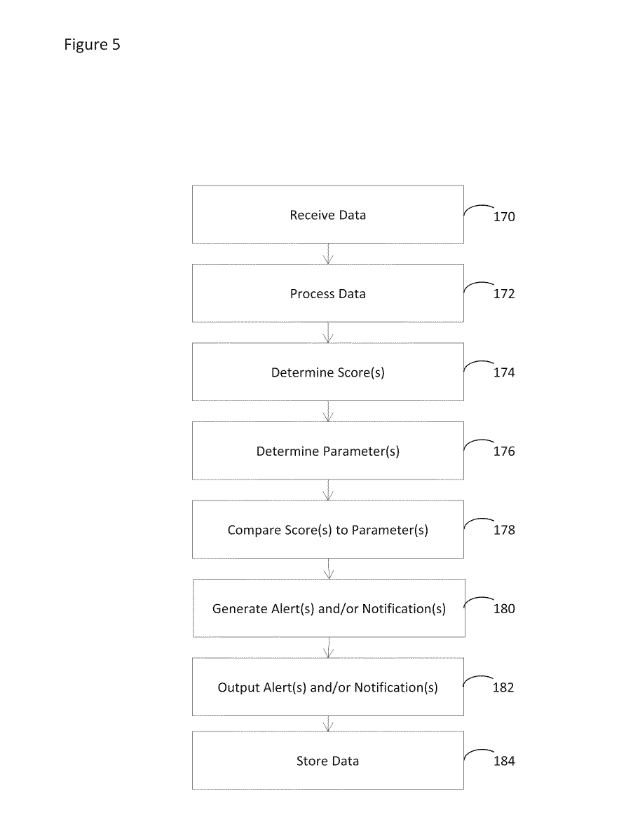

FIG. 5 is a flow diagram illustrating example operations to determine a current nitrogen status and automatically output at least one alert or notification, in accordance with one or more aspects of this disclosure. For purposes of illustration, the example operations are described below within the context of nitrogen status determination and alert system 100 and server 104, as shown in FIGS. 1 and 2.

NSDG 116 can receive data for a region of interest that includes growing crops (170). The data for the region of interest can include at least one of field data, crop data, and geographic data. For instance, NSDG 116, executing on one or more processors 120 of server device 104, can receive information from one or more of computing devices 102 (e.g., via user interfaces 114, a social network, etc.), database 106, sensor 108, and data feed 110, such as via communication network 112, point-to-point communications 115, or other such communication methods. Examples of received information can relate to target areas for the nitrogen status determination system, a UAV data gathering event and the data generated, an in-field sensor, commercial and/or public data, and/or data entered by a user (e.g., via a user interface 114) based on manually ascertained information. Additional examples can include information that impacts a crop's nitrogen status from a public or social network, or hail, rain, or other weather event that has occurred in the target areas. In some examples, the received data can include one or more previously generated nitrogen status determination analyses, such as data and/or alerts previously generated by NSDG 116 or another computing system and stored in, for example, database 106. In certain examples, NSDG 116 can receive data for the region of interest from a remote sensor, such as a UAV, as is further described herein.

NSDG 116 can process the received data (172). For example, NSDG 116 can partition the region of interest into a plurality of cells (e.g., a grid). Each cell can represent a portion of the region of interest. The portion (e.g., area) of the region of interest that a cell represents can, in certain examples, be determined based on configuration data (e.g., configuration data 154 illustrated in FIG. 3), such as configuration data received by NSDG 116 from one or more of user interfaces 114. In certain examples, NSDG 116 can partition the region of interest to determine the plurality of cells based on one or more default parameters, such as default parameters stored within configuration data 154. In some examples, NSDG 116 can partition the region of interest to determine the plurality of cells based at least in part on one or more nitrogen status determination accuracy parameters. For instance, by partitioning the region of interest into smaller cell sizes, NSDG 116 can possibly enable more accurate analyses with respect to each cell, and hence, the entire region of interest.

NSDG 116 can determine one or more scores for the region of interest (174). For example, NSDG 116 can determine one or more scores corresponding to a scope and extent of nitrogen deficiency within one or more of the plurality of cells and/or corresponding to the entire region of interest. One or more of the scores can, in some examples, be weighted and/or aggregated according to a priority of a category and/or subcategory associated with the received data, as is further described herein.

NSDG 116 can determine one or more parameters corresponding to the received data for the region of interest (176). For instance, the received data can include one or more categories and/or sub-categories. The one or more parameters can, in some examples, represent a value and/or range of values corresponding to acceptable nitrogen deficiency criteria, such as a range of acceptable precipitation values, temperature values, deviations from averages, and the like. In certain examples, the one or more parameters can represent one or more threshold values, such as maximum and/or minimum values (e.g., minimum precipitation values, maximum wind speed values, or other values).

In some examples, NSDG 116 can change the one or more parameters over the course of, for example, a growing season. For instance, NSDG 116 can automatically adjust one or more of the parameters based on, e.g., an elapsed time of a growing season. In certain examples, NSDG 116 can receive an indication of modified parameters, such as from one or more of user interfaces 114 (e.g., changes that are manually entered by a user, such as a farmer, adjuster, and the like). Accordingly, NSDG 116 can determine the one or more parameters as a function of a sensitivity to generate an alert (e.g., threshold deviation from parameters corresponding to acceptable nitrogen deficiency criteria), the time of year, the type of crop, the stage of the crop in its growth cycle, and the like. For instance, early in a growing season, NSDG 116 can determine the one or more parameters such that an alert is generated when deviations from parameters associated with acceptable nitrogen deficiency criteria are smaller in magnitude than later in the growing season. This is due to the higher reliance on nitrogen earlier in the growth cycle, so there is a lower threshold of acceptability in deviations from acceptable nitrogen status at this time. Such changes in the one or more parameters can generate alerts to enable a user (e.g., a farmer) to take reparative actions at the appropriate time, while possibly avoiding nuisance alerts at other points in the growing season when the amount of nitrogen needed by the plant is less.

NSDG 116 can compare the one or more scores to the one or more parameters (178). As an example, NSDG 116 can compare a determined score for a data element of the received data with one or more parameters. In some examples, NSDG 116 can weight and/or aggregate one or more scores to determine a weighted and/or aggregated score for a category and/or sub-category of the received data, as is further described herein.

NSDG 116 can generate, responsive to determining that one or more of the scores reflects nonconformance with acceptable nitrogen deficiency criteria, at least one alert or notification (180). For example, NSDG 116 can determine that the one or more scores reflects nonconformance with acceptable nitrogen deficiency criteria based on determining that the one or more scores does not satisfy one or more corresponding parameters. The at least one alert can, in some examples, include an identifier of the region of interest and/or a portion of the region of interest (e.g., cell) that reflects nonconformance with the one or more acceptable nitrogen deficiency criteria. In certain examples, the at least one alert or notification can include one or more of an indication of a degree by which the region of interest and/or portion of the region of interest deviates from the acceptable nitrogen deficiency criteria, an indication of a reason for the alert (e.g., an indication of the nonconformance with the acceptable nitrogen deficiency criteria, a recurring schedule based on a calendar configuration), a date and/or time of a last data sample, locations of determined change in crop nitrogen status, a number of cells excluded from the analysis, a number of cells and/or acres determined to have triggered the alert, a scope of the nitrogen deficiency, a severity of the nitrogen deficiency, or other information. In some examples, the at least one alert can include a recommendation for future action for the region of interest, such as a recommendation to “check a field,” a recommendation to maintain surveillance of a field on a “watch list,” a recommendation of a reparative action associated with one or more categories and/or sub-categories of data that reflects nonconformance with the acceptable nitrogen deficiency criteria, or other recommendations. In some examples, content of the at least one alert can differ based on an identifier of a role of the recipient. For instance, NSDG 116 can output an alert to an insurance agent including information that differs from an alert that is output to a farmer.

NSDG 116 can output the at least one alert and/or notification (182). For example, NSDG 116 can output the at least one alert, via communication network 112, to one or more of computing devices 102 (e.g., via user interfaces 114). In certain examples, NSDG 116 can output the at least one alert as one or more of a text message, multi-media service (MMS) message, SMS message, voice message, voicemail message, data file, or other types of messages. In certain examples, NSDG 116 can determine a distribution list that includes one or more accounts associated with the region of interest, and can output the at least one alert to each of the accounts included in the list. For instance, the list can include one or more email accounts, telephone numbers, computing device identifiers, and the like, that can, in certain examples, be associated with one or more users. Examples of such users can include, but are not limited to, farmers, crop insurance agents, crop insurance adjusters, agricultural product buyers, agricultural landlords, agricultural bankers, or other such users. In this way, NSDG 116 can output at least one alert that can notify one or more users that the determined current nitrogen status reflects nonconformance with the acceptable nitrogen deficiency criteria.

NSDG 116 can store data associated with the nitrogen status analysis (184). For instance, NSDG 116 can store data (e.g., within database 106) associated with the one or more parameters, received data that reflects nonconformance with the acceptable nitrogen deficiency criteria, the extent by which the received data reflects the nonconformance, or other data. Accordingly, NSDG 116 can use such data during subsequent analyses. That is, the described operations of FIG. 5 can be iterative in nature, such that NSDG 116 receives data, performs operations described with respect to FIG. 5, generates one or more alerts and stores data, and uses such stored data in future iterations of the operations. In this way, NSDG 116 can possibly improve the accuracy of subsequent analyses based on prior determinations and iterations of the operations.

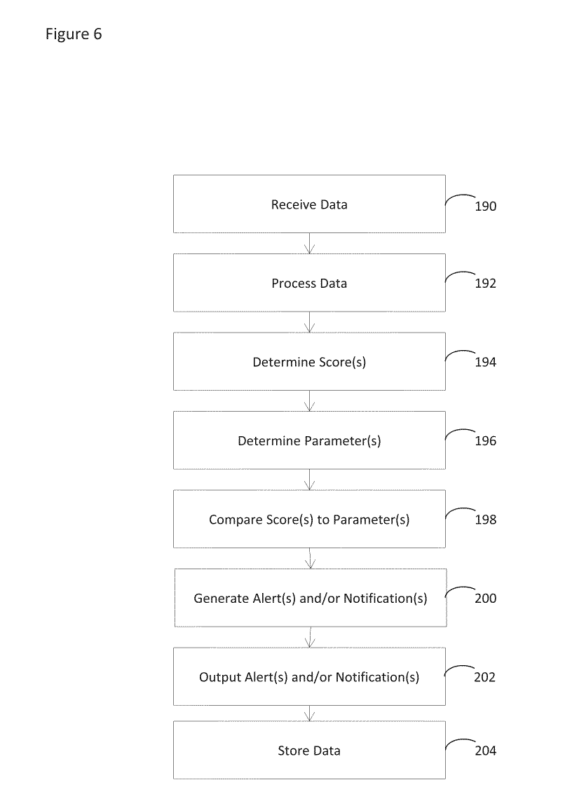

FIG. 6 is a flow diagram illustrating example operations to determine a future nitrogen status and automatically output at least one alert, in accordance with one or more aspects of this disclosure. For purposes of illustration, the example operations are described below within the context of nitrogen status determination and alert system 100 and server 104, as shown in FIGS. 1 and 2.

NSPG 118 can receive data for a region of interest that includes growing crops (190). The data for the region of interest can include at least one of field data, crop data, geographic data, and NSDG 116 data, such as that data stored within database 106. For instance, NSPG 118, executing on one or more processors 120 of server device 104, can receive information from one or more of computing devices 102 (e.g., via user interfaces 114, a social network, etc.), database 106, sensor 108, and data feed 110, such as via communication network 112, point-to-point communications 115, or other such communication methods. Examples of received information can relate to current nitrogen status analysis, such as that received from NSDG 116, forecasted weather conditions (e.g., forecasted rainfall, hail, wind, temperatures, etc.), and models or algorithms of the established rate of nitrogen transformations and processes in the soil under particular environmental circumstances (e.g., denitrification, mineralization, leaching, etc.).

NSPG 118 can process the received data (192), determine score(s) (194), determine parameter(s) (196), compare score(s) to parameter(s) (198), generate alert(s) and/or notification(s) (200), output alert(s) and/or notification(s) (202), and store data (204), in the same manner as NSDG 116 can process the received data (172), determine score(s) (174), determine parameter(s) (176), compare score(s) to parameter(s) (178), generate alert(s) and/or notification(s) (180), output alert(s) and/or notification(s) (182), and store data (184) in FIG. 5.

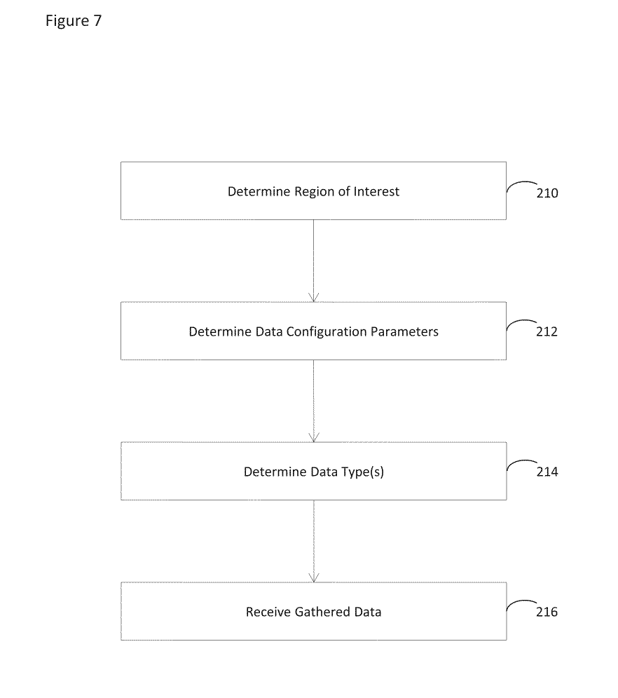

FIG. 7 is a flow diagram illustrating further details of operation 170 as shown in FIG. 5, in accordance with one or more aspects of this disclosure. NSDG 116 can determine a region of interest (210). For instance, NSDG 116 can receive configuration parameters (e.g., via one or more of user interfaces 114) that define the boundaries (e.g., physical boundaries, such as latitude and longitude data) of the region of interest. In some examples, the region of interest can include a field (e.g., a field of growing crops). In other examples, the region of interest can include one or more portions of a field of growing crops. For instance, a user can define a portion of the field to be analyzed and/or portions of the field that are not to be analyzed. Such portions of a field that are not to be analyzed can be referred to as exclusion zones, and can correspond to regions associated with physical features such as building sites, prior building sites, areas of prior manure spills, or other regions that are not to be included in the nitrogen status determination analysis.

NSDG 116 can determine data configuration parameters corresponding to the region of interest (212). For instance, NSDG 116 can determine the number, size, and/or location of boundaries by which to partition the region of interest to determine a plurality of cells, each of the cells representing a portion of the region of interest. Such cell boundary information can be determined by NSDG 116 (e.g., based on default parameters) and/or received by NSDG 116, such as from one or more of user interfaces 114.

NSDG 116 can determine one or more data types included in the received data for the region of interest (214). As an example, NSDG 116 can receive an indication of the one or more data types from one or more of user interfaces 114. NSDG 116 can receive gathered data for the region of interest (216). For instance, NSDG 116 can receive data for the region of interest from one or more of sensor 108 (e.g., one or more remote sensors, such as a UAV, a satellite, an aircraft, and the like), data feed 110, database 106, and computing devices 102.

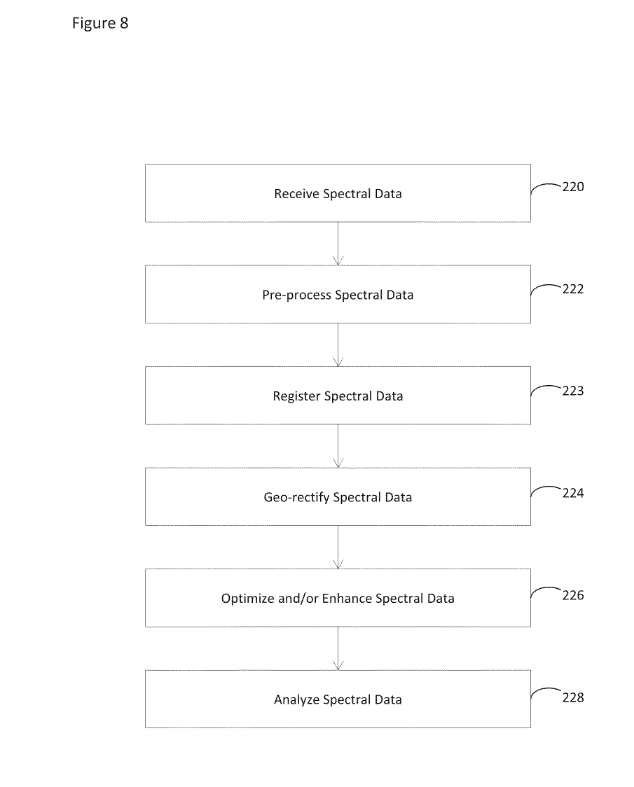

FIG. 8 is a flow diagram illustrating further details of operation 172 as shown in FIG. 5, in accordance with one or more aspects of this disclosure. FIG. 8 illustrates example operations of NSDG 116 to receive and analyze spectral data according to techniques of this disclosure. NSDG 116 can receive spectral data for the region of interest (220). For instance, NSDG 116 can receive spectral data, such as visible-spectrum data, ultra-violet spectral data, infrared spectral data, hyperspectral wavelength image data, or other types of spectral data. In certain examples, NSDG 116 can receive the spectral data in the form of multiple files, each of the files either corresponding to a different sub-region of the region of interest or being acquired from a separate sensor.

NSDG 116 can pre-process the received spectral data (222). For example, NSDG 116 can assemble (e.g., “stitch”) the multiple spectral files together to generate a spectral file corresponding to the entire region of interest. NSDG 116 can, in some examples, pre-process the spectral data to discard spectral data that is not associated with the region of interest or is below a threshold quality (e.g., a threshold clarity, brightness, contrast, and the like).

NSDG 116 can register the spectral data (223) if it originates from two or more sensors. For example, NSDG 116 can associate or transform spectral data from different datasets into one coordinate system. Spectral data may be from multiple sensors, dates, altitudes, etc. Registration is necessary in order to be able to compare or integrate the data obtained from these different measurements.

NSDG 116 can geo-rectify the spectral data (224). For example, NSDG 116 can associate portions of the pre-processed spectral data with latitude and longitude values corresponding to known latitude and longitude values that the portion of the data represents. NSDG 116 can optimize and/or enhance the geo-rectified spectral data (226). For instance, NSDG 116 can adjust a brightness, contrast, or other image parameters to enhance one or more of the spectral parameters (e.g., to make a boundary and/or image of nitrogen deficiency more visually apparent). NSDG 116 can analyze the spectral data (228). As an example, NSDG 116 can juxtapose the geo-rectified spectral data against previous data of the same crop to determine a change in the nitrogen status and/or growth status over time.

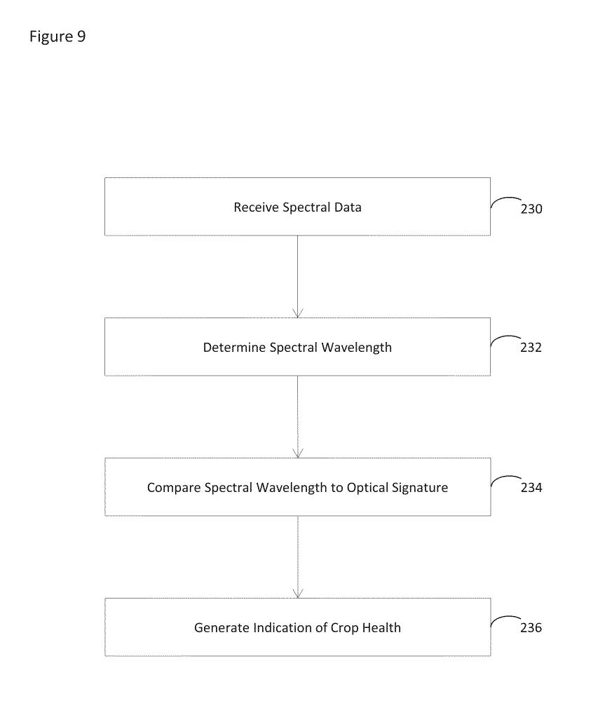

FIG. 9 is a flow diagram illustrating further details of operation 174 as shown in FIG. 5, in accordance with one or more aspects of this disclosure. In particular, FIG. 9 illustrates example operations of NSDG 116 to generate an indication of crop health using spectral wavelength data. NSDG 116 can receive spectral data for the region of interest (230). For example, NSDG 116 can receive spectral data from an in-field image sensor (e.g., included in a camera device) and/or remote spectral sensor, such as from a camera device carried by one or more of a UAV, an aircraft, a satellite, and a field-passing device. NSDG 116 can determine spectral wavelength data from the received spectral data (232). NSDG 116 can compare the spectral wavelength data to one or more optical signatures (234). Using the optical signatures, NSDG 116 can determine an indication of crop health based on the comparison (236).

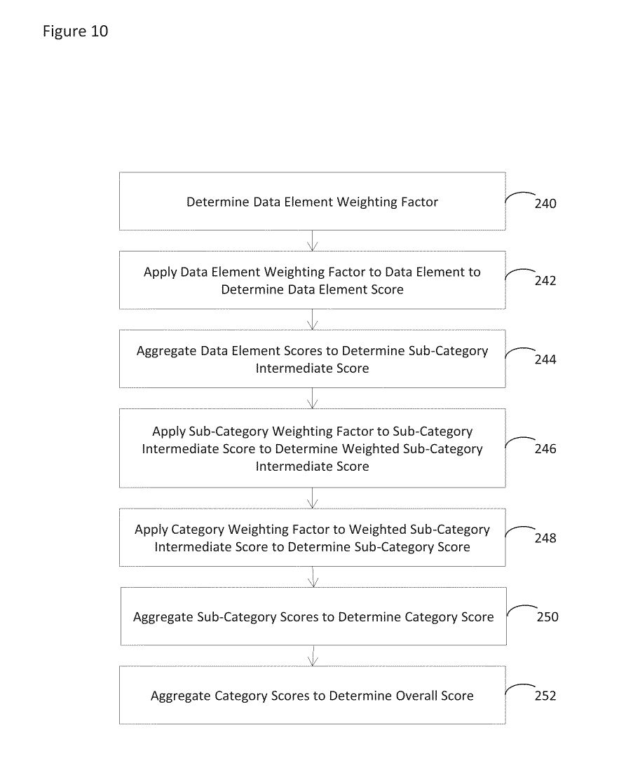

FIG. 10 is a flow diagram illustrating further details of operation 174 as shown in FIG. 5, in accordance with one or more aspects of this disclosure. NSDG 116 can determine a data element weighting factor corresponding to a data element of received data for the region of interest (240). For instance, NSDG 116 can access configuration data (e.g., stored in database 106) to determine a weighting factor associated with the data element, as is further described herein. NSDG 116 can apply the data element weighting factor to the data element to determine a data element score (242). For example, NSDG 116 can multiply a value of the data element by a value of the weighting factor to determine the data element score. Another term for a weighting factor may be a “modifier” in that the relevance of this data element is multiplied or diminished.

NSDG 116 can aggregate data element scores to determine a sub-category intermediate score (244). For instance, the received data for the region of interest can include one or more categories. Examples of categories can include, but are not limited to, production history data, weather event data, sensor data, land data (including topography and groundwater data), soil data, field data (e.g., field shape, size, and location), improvements data (e.g., improvements to the region of interest, such as addition of drain tile or other improvements), insurance claim history data, planted crop data, planting and harvesting event data, manually entered data, adjacent event data (e.g., weather events such as hail, disease, infestation, or other events associated with a location proximate to the region of interest), or other categories of data. At least one of the categories can include one or more sub-categories. For instance, a production history data category can include sub-categories such as yield environment, crop rotation, yield consistency, type of tillage, plant stage, or other sub-categories. NSDG 116 can aggregate the data element scores within sub-categories to determine sub-category intermediate scores for the sub-categories. As one example, NSDG 116 can aggregate the data element scores by summing the data element scores. In other examples, NSDG 116 can aggregate the data element scores by multiplying, averaging, or by using other aggregation techniques.

NSDG 116 can apply a sub-category weighting factor to the sub-category intermediate score to determine a weighted sub-category intermediate score (246). NSDG 116 can apply a category weighting factor to the weighted sub-category intermediate score to determine a sub-category score (248). NSDG 116 can aggregate sub-category scores to determine a category score (250). NSDG 116 can aggregate category scores to determine an overall score (252). NSDG 116 can determine the overall score with respect to an entire region of interest, a portion of the region of interest (e.g., a cell), or both.

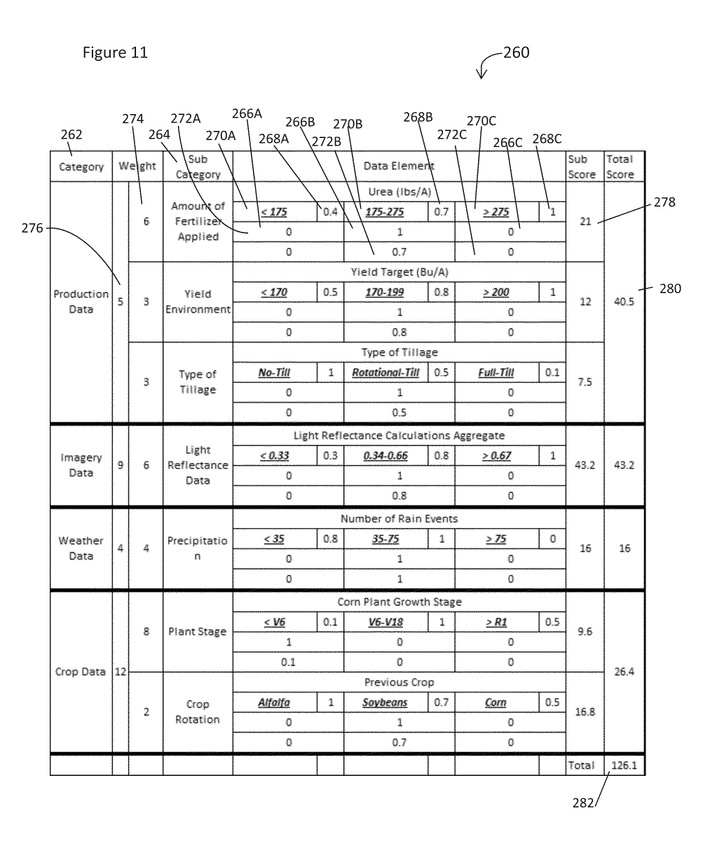

FIG. 11 illustrates a table 260 that represents an example scoring matrix for use in a method of determining a current and/or future nitrogen status of growing crops within a region of interest, in accordance with one or more aspects of this disclosure. As illustrated in FIG. 10, table 260 can include category 262 of received data for a region of interest. However, while illustrated with respect to one category, in certain examples, table 260 can include a plurality of categories, such as two categories, three categories, ten categories, or other numbers of categories. In the illustrated example, category 262 corresponds to four data categories, production data, imagery data, weather data, and crop data. Other example categories can include, but are not limited to, field data, manually ascertained data, geographic data, farm equipment data, configuration data, or other categories of data.

As further illustrated in FIG. 11, category 262 can include sub-categories 264, including amount of fertilizer applied, yield environment, type of tillage, light reflectance data, precipitation, plant stage, and crop rotation. In certain examples, sub-categories 264 can include more or fewer sub-categories. In general, sub-categories 264 can include any number of sub-categories (e.g., zero, one, two, five, fifty, or other numbers of sub-categories) that are deemed relevant to a category of data.

NSDG 116 can classify received data for the region of interest according to a sub-category and/or category. Received data can take the form of a binary data element, such as data elements 266A-266C. NSDG 116 can determine a data element weighting factor for each of the one or more binary data elements, such as data element weighting factors 268A-268C. In some examples, NSDG 116 can determine the data element weighting factors for each of the one or more data elements based on a comparison of the data element to one or more threshold values. For instance, as illustrated in FIG. 11, NSDG 116 can determine that data element weighting factor 268A is to be applied to binary data element 266A based on a comparison of data element 266A with threshold value 270A. Similarly, NSDG 116 can determine that data element weighting factor 268B is to be applied to binary data element 266B based on a comparison of data element 266B with threshold values 250B (i.e., a range of threshold values). NSDG 116 can determine that data element weighting factor 268C is to be applied to binary data element 266C based on a comparison of data element 266C with threshold value 270C. In this way, as illustrated in FIG. 11, NSDG 116 can determine a plurality of data element weighting factors to be applied to a plurality of data elements corresponding to a plurality of sub-categories within the category. Similarly, NSDG 116 can determine such data element weighting factors for a plurality of sub-categories within a plurality of categories.

NSDG 116 can apply the determined data element weighting factors (e.g., data element weighting factors 268A-268C) to the data elements (e.g., data elements 266A-266C) to determine a plurality of data element scores, such as data element scores 272A-272C. For example, NSDG 116 can multiply binary data element 266A by weighting factor 268A to determine data element score 272A. Similarly, NSDG 116 can multiply binary data element 266B by weighting factor 268B to determine data element score 272B, and can multiply binary data element 266C by weighting factor 268C to determine data element score 272C.

NSDG 116 can aggregate (e.g., sum, multiply, average, and the like) the data element scores (e.g., data element scores 272A-272C) to determine a sub-category sub-score. For instance, NSDG 116 can sum data element scores 272A-272C to determine the sub-category sub-score (e.g., summing by the equation “0+0.7+0” to determine a sub-score of “0.7”). NSDG 116 can apply a sub-category weighting factor, such as sub-category weighting factor 274 to determine a sub-category intermediate score. For instance NSDG 116 can multiply sub-category weighting factor 274 by the determined sub-category sub-score (e.g., “0.7” in this example) to determine a sub-category intermediate score (e.g., “4.2” in this example). NSDG 116 can apply (e.g., multiply) a category weighting factor, such as category weighting factor 276, to the determined sub-category intermediate score to determine a sub-category score for the sub-category. For instance, NSDG 116 can multiply category weighting factor 276 (e.g., “5” in this example) by the determined sub-category intermediate score (e.g., “4.2” in this example) to determine subcategory score 278 (e.g., “21” in this example). As illustrated, NSDG 116 can determine a plurality of sub-category scores for a plurality of sub-categories. NSDG 116 can aggregate the sub-category scores to determine a category score, such as category score 280. In some examples, NSDG 116 can aggregate a plurality of determined category scores to determine an overall score 282. For instance, NSDG 116 can determine an overall score 282 (e.g., for a portion of a region of interest such as a cell, for the entire region of interest, or for other areas) as the sum of a plurality of determined category scores.

Each of the above-described weighting factors (i.e., data element weighting factors, sub-category weighting factors, and category weighting factors) can be different or the same. In addition, each of the weighting factors can be modified, such as automatically by NSDG 116 and/or in response to input received from one or more of user interfaces 114. For instance, a user can modify one or more of the weighting factors, such as by providing user input via one or more of user interfaces 114 to adjust a weighting factor and/or provide a new value for the weighting factor.

The scoring matrix represented by table 260 can be associated with a portion of a region of interest (e.g., a cell), an entire region of interest (e.g., a field), or both. NSDG 116 can compare one or more of the determined scores and/or values within table 260 with one or more parameters corresponding to acceptable nitrogen deficiency criteria to determine whether the nitrogen status reflects nonconformance with the acceptable nitrogen deficiency criteria. As one example, NSDG 116 can compare one or more of the data element scores with one or more parameters, and can output at least one alert in response to determining that one or more of the data element scores does not satisfy the one or more parameters (and therefore reflects nonconformance with the acceptable nitrogen deficiency criteria). As another example, NSDG 116 can compare one or more of the sub-category scores with the one or more parameters, and can output at least one alert in response to determining that one or more of the sub-category scores do not satisfy the one or more parameters. As yet another example, NSDG 116 can compare one or more of the category scores and/or total score with the one or more parameters, and can output at least one alert in response to determining that one or more of the category scores and/or total score does not satisfy the one or more parameters.

Accordingly, NSDG 116 can determine a nitrogen status for a region of interest at a level of granularity based on a size of a cell of the region of interest, or for the region of interest as a whole. NSDG 116 and/or a user (e.g., via user interfaces 114) can modify one or more of the parameters and/or the weighting factors, thereby modifying a level of sensitivity of the generation of alerts and/or a contribution of one or more forms of data to the generation of alerts.

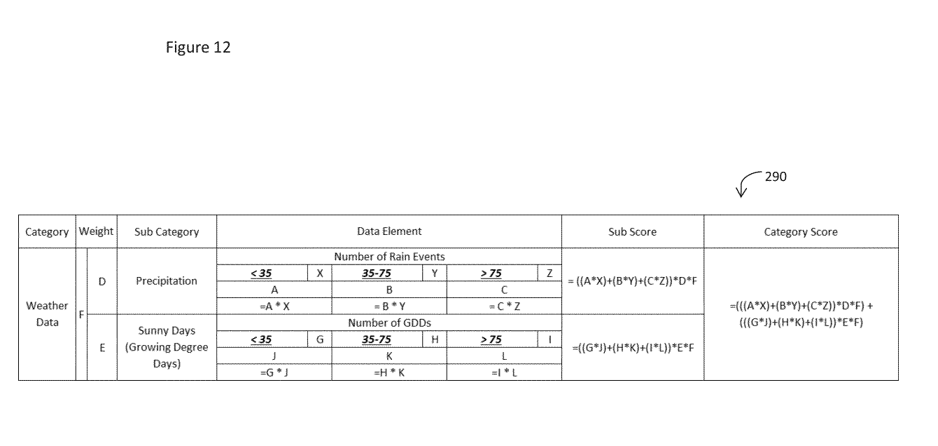

FIG. 12 illustrates table 290 that represents example calculations that can be used to determine a nitrogen status of growing crops within a region of interest, in accordance with one or more aspects of this disclosure. Specifically, table 290 further illustrates example calculations as described above with respect to FIG. 11 that can be used to determine data element scores, sub-category scores, and a category score.

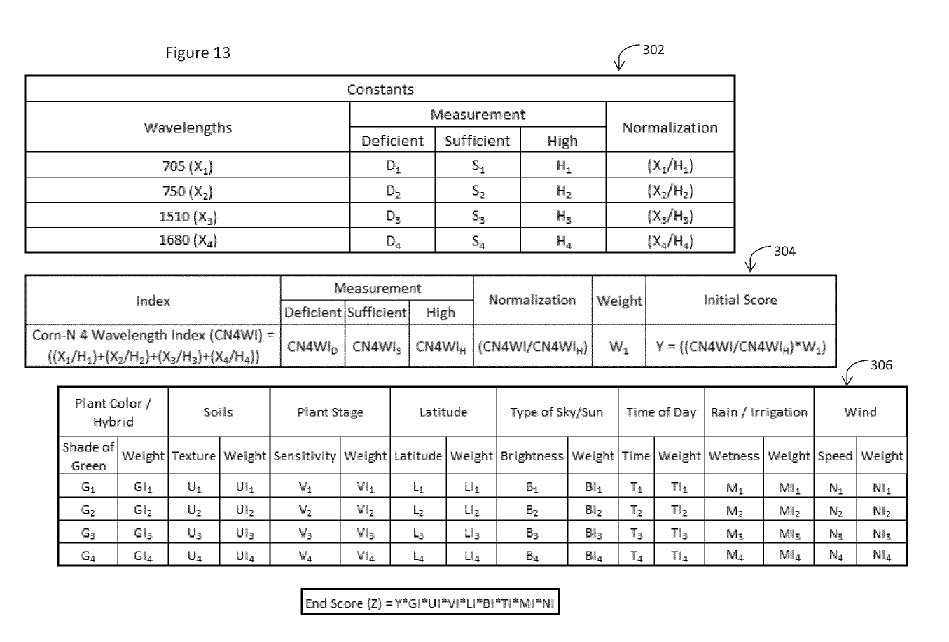

FIG. 13 illustrates tables 302, 304, and 306 that represent the sample spectral analysis algorithms that determine the light reflectance data sub-category value with respect to FIG. 11. Tables 302, 304, and 306 represent one sample method to determine a value from 0 to 1 that demonstrates the light reflectance of each cell from the area of interest. This value is then used in calculations, such as those described in FIGS. 11 and 12, in order to determine a more accurate and precise nitrogen status. In table 302, the CN4WI is an example vegetative index that incorporates four wavelengths (705 nm, 750 nm, 1510 nm, and 1680 nm). These wavelengths are illustrated in table 302. The CN4WI is measured as being deficient, sufficient, or high, and then normalized and weighted to determine the initial score in table 304. This initial score is then modified based on the variables of the field, crop, and environment to determine a final light reflectance value in table 306 that can be used in example scoring matrix 260 in FIG. 11. The modification process incorporates variables of the field, crop, and environment. Example modifiers include the plant color/hybrid type, the soil types, the plant stage, the latitude, the type of sky/brightness of sun, the time of day, the rain/irrigation, and the wind speeds. These modifiers are used to determine the light reflectance data sub-category score with respect to FIG. 11.

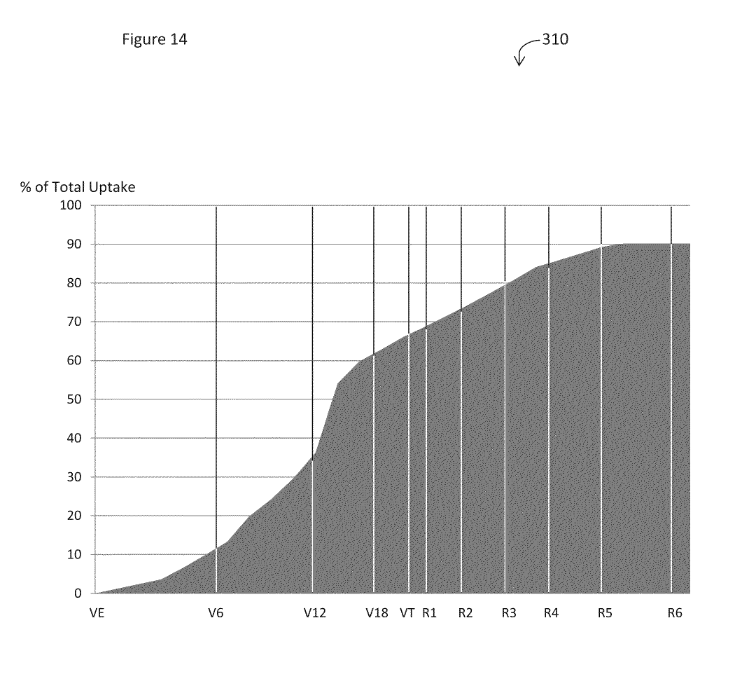

FIG. 14 illustrates graph 310 that represents the established nitrogen uptake rate for corn in different phases of its growth stages. The fact that corn requires a greater amount of nitrogen at various stages in its life cycle is a well known fact. Graph 310 is representative of the research and illustrates that nitrogen uptake rates increase sharply between V8 and VT for corn plants. Following this period, corn plants continue to uptake nitrogen, but at a more gradual rate, until it levels off at full corn plant maturity (R6). This graph illustrates the importance of applying nitrogen in the appropriate amounts and at the appropriate times so that the corn plant can uptake its full absorptive capabilities at the point of its growth development while minimizing excessive nitrogen application and the resultant leaching into the environment.

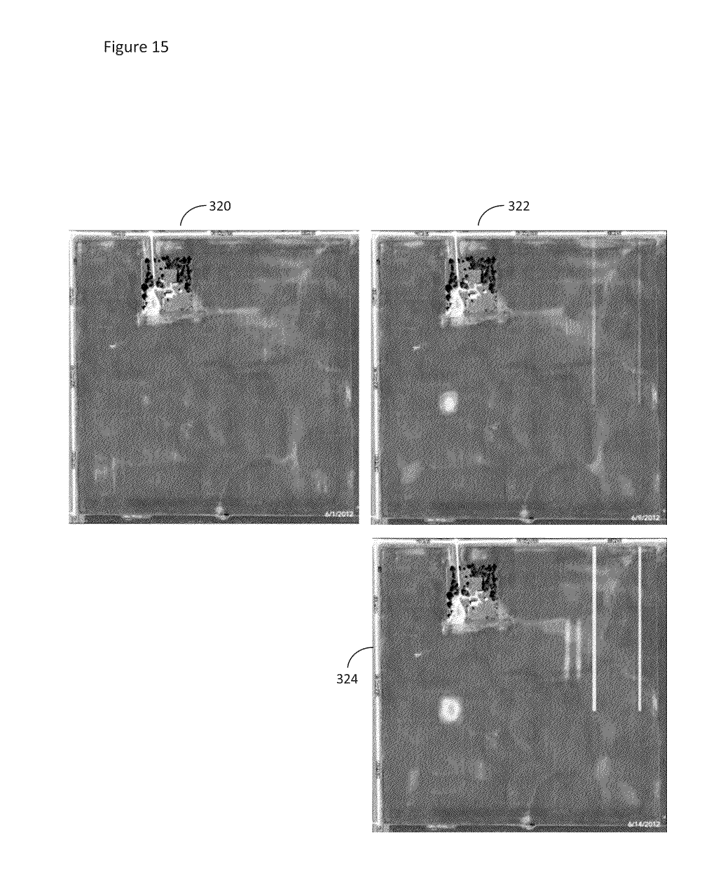

FIG. 15 illustrates example images 320, 322, and 324 that can be used to determine a nitrogen status for a region of interest, in accordance with one or more aspects of this disclosure. Images 320, 322, and 324 represent example image data that can be received by NSDG 116 (e.g., via a UAV). Images 320, 322, and 324 represent images of a field captured over a period of days (e.g., image 320 captured at a first time, image 322 captured at a second, later time, and image 324 captured at a third time, later than the second time). Images 320, 322, and 324 illustrate changes in the condition of the crop over time. NSDG 116 can analyze images 320, 322, and 324, and can determine the nitrogen status based at least in part on the analysis. As described above, the current and/or future nitrogen status can be determined, for example, based at least in part on texture, color (traditional, infrared, etc.), patterns, tone, shadows, and temperature combined with other available data. Images 320, 322, and 324 are examples of image data that the NSDG 116 can receive. In some examples, certain visual and other display techniques can be used to make the crop quality deficiencies more visually apparent from the images. For instance, NSDG 116 can amplify visual indicators of the growth of the crop by electronic means to enhance the image and illustrate any deficiencies in a more visually apparent manner. As another example, NSDG 116 can use time-lapse techniques, such that changing crop conditions can be visually observed over time through the use of multiple images juxtaposed together.

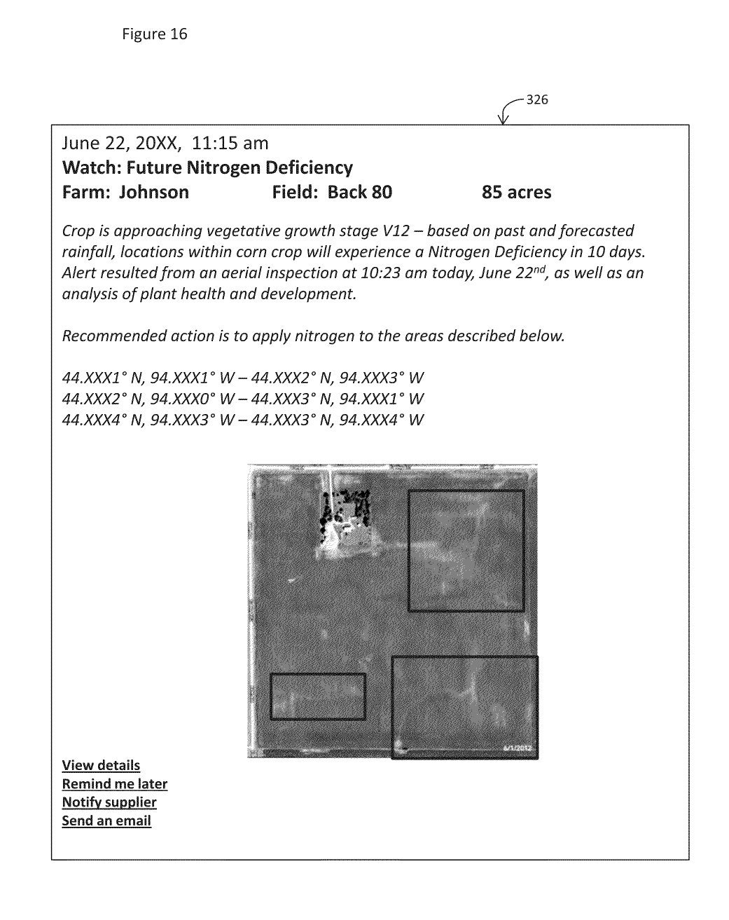

FIG. 16 illustrates an example user interface 326 including an alert, in accordance with one or more aspects of this disclosure. User interface 326 is an example user interface that can be output, for display (e.g., at one or more of user interfaces 114), by NSDG 116. FIG. 16 illustrates an example alert output by NSDG 116 after determining that the crop is approaching vegetative growth stage V12, through the use of an aerial inspection by a UAV as well as a predictive modeling process based on the inputted data. In this example, NSDG 116 determines that three portions of the region of interest will have a nitrogen deficiency in ten days and for ideal crop absorption rates at this growth stage, there will be insufficient nitrogen in the soil. This is determined through an algorithm, such as example scoring matrix 260 in FIG. 11, incorporating data such as field data (i.e., soil types, presence of organic matter, etc.), production data (i.e., seed planted, date of seed planted, location of tile, tillage practices, etc.), weather data (i.e., recent, forecasted, or average rainfall in this area over the relevant time period), manually ascertained data (i.e., previous amounts and types of nitrogen applied, prior manure spills, etc.), geographic data (i.e., presence of ground water, slope, elevation, etc.), crop data (i.e., image, color, heat, etc.), farm equipment data (i.e., previous yield, as-planted data, as-applied data, etc.), configuration data (i.e., areas to exclude, thresholds of nitrogen presence acceptability, etc.), and optical signature data (i.e., healthy plant chlorophyll benchmarks, computer vision analytics, etc.).

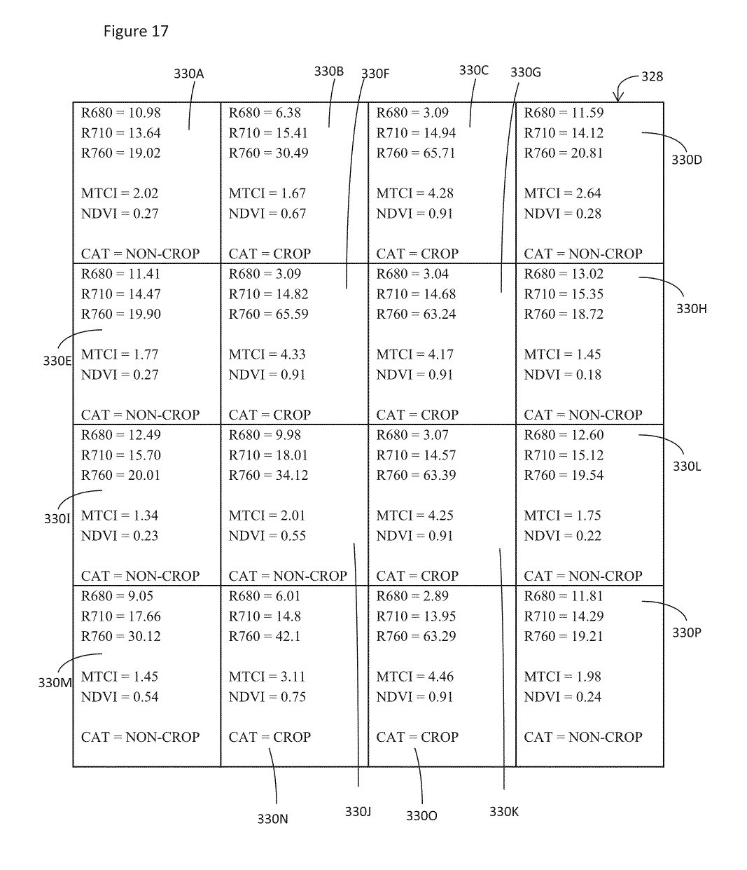

FIG. 17 is a block diagram illustrating an example spectral index data map 328 that can be used to determine a nitrogen stress status of growing crops based on image data corresponding to the growing crops and excluding image data corresponding to an absence of growing crops. Spectral index data map 328, as illustrated in FIG. 17, includes a plurality of tiles 330A-330P (collectively referred to herein as “tiles 330”). NSDG 116, for example, can receive image data for a region of interest that includes growing crops, such as a field of crops, a portion of a field of crops, multiple fields of crops, or other regions of interest that include growing crops. NSDG 116 can generate spectral index data map 328 based on the received image data. In some examples, such as the illustrated example of FIG. 17, the outer boundaries of the region of interest can be represented by the outer boundaries of spectral index data map 328. That is, NSDG 116 can geo-rectify the received image data to correlate the received image data with corresponding geography that the image data represents. In other examples, the boundaries of the region of interest may not coincide directly with, but rather may be approximated by the outer boundaries of spectral index data map 328.

NSDG 116 can segregate the image data for the region of interest into the plurality of tiles 330, such that each of tiles 330 includes image data corresponding to a different geographical portion of the region of interest. NSDG 116 can determine a size, shape, and/or number of tiles 330 by which to segregate the image data based on, for example, an optical resolution of the image data, a size of the region of interest, or configuration data (e.g., stored at storage device(s) 128 of server device 104) specifying a number and/or size of tiles 330. In some examples, each of tiles 330 can represent a single pixel of the received image data. In other examples, each of tiles 330 can represent an aggregation of pixels of the received image data. In general, as the geographical area of the region of interest represented by the image data included in each of tiles 330 decreases, the spatial precision of a determined nitrogen stress status based on information included in tiles 330 increases. As such, it should be understood that while for purposes of ease of illustration and discussion tiles 330 are illustrated as including sixteen of tiles 330, in some examples tiles 330 can include more than sixteen tiles, such as tens or hundreds of thousands of tiles 330 or more.

The received image data can be multispectral image data including reflectance data measured in multiple wavelength ranges that are usable by NSDG 116 to determine a spectral index value that correlates with a nitrogen content (or deficiency) of vegetation such as corn, wheat, and potatoes. Example spectral indices usable by NSDG 116 to determine the nitrogen content include, but are not limited to, NDVI, MTCI, and NDNI index values. As illustrated in FIG. 17, the multispectral image data can include data representing a percentage of light reflectance within a red region of the electromagnetic spectrum (including a 680 nanometer (nm) wavelength), a percentage of light reflectance within a red edge region of the electromagnetic spectrum (including a 710 nm wavelength), and a percentage of light reflectance within a near infrared region of the electromagnetic spectrum (including a 760 nm wavelength). Such wavelength ranges (i.e., red, red edge, and near infrared) can, in certain examples, be considered narrowband wavelength ranges, and are usable by NSDG 116 to determine both MTCI values (based on each of the red, red edge, and near infrared wavelengths) and NDVI values (based on only the red and near infrared wavelengths). However, in other examples, such as where NSDG 116 does not determine one or more of MTCI values or NDVI values, the received image data may include only a subset of the red, red edge and near infrared wavelengths, or different reflectance wavelengths. For instance, in examples where NSDG 116 determines a nitrogen stress status of the growing crops based on NDVI values (e.g., rather than MTCI values), the received image data may not include reflectance data from red edge wavelength ranges (which are not used by NDVI techniques).

While in the example of FIG. 17 the red region includes a wavelength of 680 nm, the red edge region includes a wavelength of 710 nm, and the near infrared region includes a wavelength of 760 nm, it should be understood that wavelengths from each of the red region, the red edge region, and the near infrared region can have wavelengths from a range of wavelengths. For instance, reflectance data from the red region can range from 600 nm to 700 nm. Similarly, reflectance data from the red edge region can range from 695 nm to 755 nm, and reflectance data from the near infrared region can range from 750 nm to 1000 nm.

NSDG 116 can identify one or more portions of the received image data that correspond to growing crops within the region of interest and one or more portions of the image data that correspond to an absence of the growing crops (e.g., soil, ground cover, debris, or other non-crop portions). In some examples, portions of the image data can correspond to tiles 330. That is, NSDG 116 can determine, for each of tiles 330, whether image data included in the respective one of tiles 330 corresponds to growing crops or whether the image data corresponds to an absence of the growing crops.

As an example, NSDG 116 can determine an NDVI value for each of tiles 330 according to the following equation:

$$NDVI = \frac{NIR - Red}{NIR + Red} \qquad Equation ( 1 )$$

where NDVI is the NDVI index value, NIR is the percentage of reflectance at a wavelength in the near infrared region (e.g., 760 nm), and Red is the percentage of reflectance at a wavelength in the red region (e.g., 680 nm).

NSDG 116 can assign each of tiles 330 to either a crop category (i.e., corresponding growing crops) or a non-crop category (i.e., corresponding to an absence of growing crops) based on the determined NDVI value for the respective tile. For instance, NSDG 116 can compare the determined NDVI value to a threshold value within a range of, e.g., 0.3 to 0.6, that correlates to a bifurcation between crop reflectance and non-crop reflectance indices, and can assign the respective tile to one of the crop category and the non-crop category based on the comparison. In the example of FIG. 17, NSDG 116 compares the determined NDVI value for each of tiles 330 to a threshold value of 0.55 and assigns the respective tile to a non-crop category if the respective NDVI value is less than 0.55, and to a crop category if the respective NDVI value is greater than or equal to 0.55. In this way, NSDG 116 can determine which of tiles 330 includes image data that corresponds to growing crops within the region of interest, and which of tiles 330 includes image data that corresponds to an absence of growing crops.

As further illustrated, NSDG 116 can determine a spectral index value for tiles 330, such as an MTCI value, and can use the determined spectral index value to determine a nitrogen stress status for growing crops within the region of interest. As in the example of FIG. 17, NSDG 116 can determine the spectral index value (e.g., the MTCI value) for each of tiles 330. In other examples, NSDG 116 can determine the spectral index value for only those tiles assigned to a crop category. NSDG 116 can determine an MTCI value according to the following equation:

$$MTCI = \frac{NIR - RedEdge}{RedEdge - Red} \qquad Equation ( 2 )$$

where MTCI is the MTCI index value, NIR is the percentage of reflectance at a wavelength in the near infrared region (e.g., 760 nm), RedEdge is the percentage of reflectance at a wavelength in the red edge region (e.g., 710 nm), and Red is the percentage of reflectance at a wavelength in the red region (e.g., 680 nm). Because MTCI values correlate to nitrogen content within vegetation, NSDG 116 can determine a nitrogen stress status of growing crops within the region of interest based on the determined MTCI values for those of tiles 330 that are included in a crop category, as is further described below.

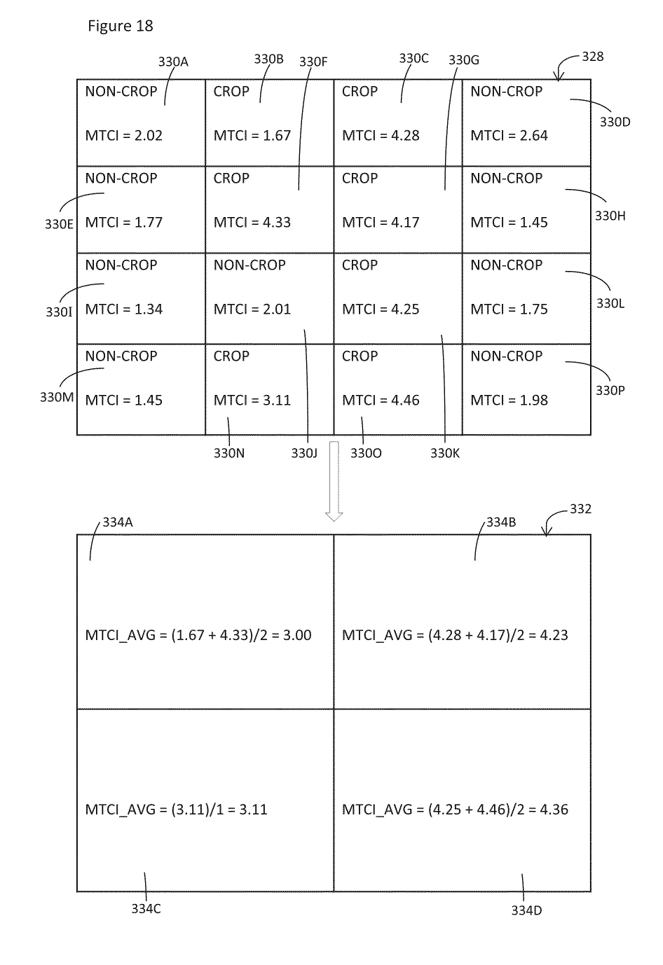

FIG. 18 is a block diagram illustrating example operations to generate resampled spectral index data map 332 based on portions of received image data that correspond to growing crops and excluding portions of the image data that correspond to an absence of the growing crops. In the example of FIG. 18, NSDG 116 generates resampled spectral index data map 332 based on resampling operations performed with respect to spectral index data map 328, as is illustrated by the directional arrow extending from spectral index data map 328 to resampled spectral index data map 332.

As illustrated in FIG. 18, resampled spectral index data map 332 includes tile groups 334A-334D (collectively referred to herein as “tile groups 334”). NSDG 116 can group the plurality of tiles 330 to form the plurality of tile groups 334. For instance, as in the example of FIG. 18, tile group 334A represents a grouping of tiles 330A, 330B, 330E and 330F. Tile group 334B represents a grouping of tiles 330C, 330D, 330G, and 330H. Tile group 334C represents a grouping of tiles 3301, 330J, 330M, and 330N. Tile group 334D represents a grouping of tiles 330K, 330L, 3300, and 330P. While in the example of FIG. 18, resampled index data map 332 includes four tile groups 334, in other examples, resampled index data map 332 can include more or fewer than four tile groups. Similarly, while each of tile groups 334 includes (or is based on) four respective ones of tiles 330, in other examples, tile groups 334 can include (or be determined based on) more or fewer than four respective ones of tiles 330. In general, while the example of FIG. 18 is described with respect to sixteen tiles 330 and four tile groups 334, tiles 330 and tile groups 334 can include N tiles and tile groups, where N is an arbitrary number that can be different between tiles 330 and tile groups 334.

NSDG 116 associates tile groups 334 with a geographical area corresponding to the aggregate of the geographical areas associated with individual tiles 330 within the respective one of tile groups 334. As an example, NSDG 116 associates image data included in tile group 334A with a geographical area of the region of interest that is the same as a geographical area associated with the aggregate of tiles 330A, 330B, 330E, and 330F. In this way, NSDG 116 maintains geo-rectification of the image data after the grouping operations.

As further illustrated in FIG. 18, NSDG 116 can determine an MTCI value for each of tile groups 334 as an average value of each of tiles 330 included in the respective one of tile groups 334 that are included in a crop category. For example, NSDG 116 determines the MTCI value for tile group 334A (illustrated as MTCI_AVG) by averaging the MTCI values of tile 330B and tile 330F included in tile group 334A. In this way, NSDG 116 assigns an average MTCI value for the entire geographical area associated with tile group 334A that is based on MTCI values of tiles 330B and 330F that are included in a crop category (i.e., corresponding to growing crops) and excluding MTCI values of tiles 330A and 330E that are included in a non-crop category (i.e., corresponding to an absence of growing crops). NSDG 116 can perform similar operations to generate average MTCI values for each of tile groups 334B, 334C, and 334D. While described with respect to the example of FIG. 18 as determining average MTCI values for each of tile groups 334, aspects of this disclosure are not so limited, meaning that rather than determine average MTCI values, NSDG 116 can, in certain examples, utilize other aggregation techniques having a central tendency, such as weighted averaging techniques, midrange techniques, midhinge techniques, trimean techniques, or other techniques to determine MTCI values of tile groups 334. Accordingly, NSDG 116 can effectively resample the spectral index data included in spectral index data map 328 to generate resampled spectral index data map 332 that both maintains geo-rectification of the image data and includes MTCI values (e.g., average values, or other values based on central tendency techniques) that are based on image data that corresponds to growing crops within the region of interest and excludes image data that corresponds to an absence of the growing crops. As such, NSDG 116 can use resampled spectral index data map 332 to determine a nitrogen stress status of the growing crops within the region of interest while excluding reflectance data corresponding to soil, debris, ground cover, or other non-crop portions that can skew the MTCI values toward low-stress indications, thereby enabling a more accurate assessment of the nitrogen stress status of the crops at early stages of crop development (e.g., prior to canopy closure).

In certain examples, NSDG 116 can assign values to those of tiles 330 that are included in a non-crop category based on a central tendency of tiles 330 within a threshold distance of the respective one of tiles 330 that are included in a crop category. For example, NSDG 116 can assign an MTCI value to tile 330A as an average MTCI value (or other centrally-tended value) of those of tiles 330 within a threshold number of tiles (e.g., one tile, two tiles, or other numbers of tiles) from tile 330A that are assigned to a crop category. For instance, NSDG 116 can assign an MTCI value to tile 330A as the average MTCI value of tiles 330B and 330F that are within one tile distance from tile 330A and included in a crop category. As another example, NSDG 116 can assign an MTCI value to tile 330J as an average of MTCI values of tiles 330F, 330C, 330K, 3300, and 330N that are within one tile distance from tile 330J and included in a crop category (e.g., an MTCI value 4.06 in this example). In such examples, NSDG 116 can determine a second averaged (or centrally-tended) crop mask that assigns MTCI values to tiles included in a non-crop category based on MTCI values of tiles included in the crop category.

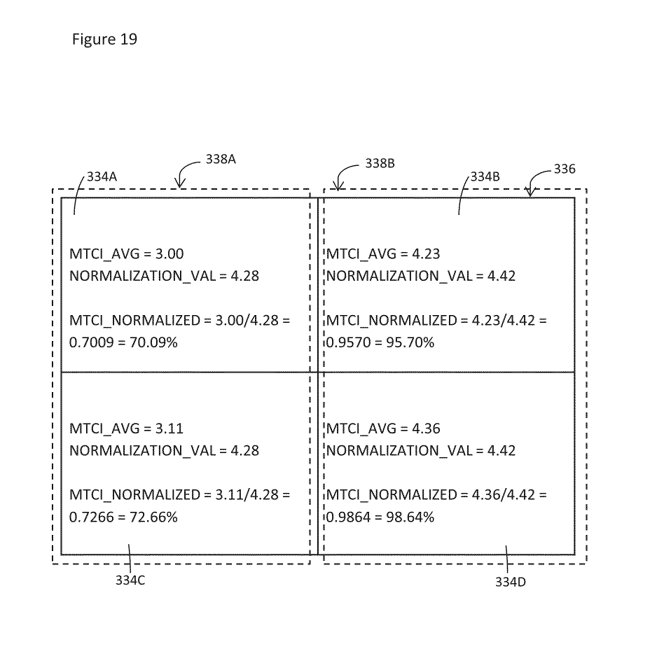

FIG. 19 is a block diagram illustrating example operations to generate normalized spectral index data map 336. As illustrated in FIG. 19, normalized spectral index data map 336 includes tile groups 334, each of which is associated with an average MTCI value, as is described above. In addition, NSDG 116 determines a normalization value for each of tile groups 334 based on a normalization zone within which the respective one of tile groups 334 is included. For instance, as illustrated in FIG. 19, each of tile group 334A and tile group 334C are included in normalization zone 338A. Each of tile group 334B and 334D are included in normalization zone 338B (normalization zones 338A and 338B are collectively referred to herein as “normalization zones 338”). Normalization zones 338 can correspond to differing hybrids of a same type of crop, different crops, or other differentiating features that can result in varying MTCI values between crops included in each of normalization zones 338. While illustrated as including two normalization zones 338, in other examples, the region of interest (and hence normalized spectral index data map 336) can include greater or fewer than two normalization zones.

NSDG 116 determines a normalization value for each of normalization zones 338 as a threshold spectral index value (e.g., MTCI value) based on, for example, a probability distribution of MTCI values associated with tiles included in the respective one of normalization zones 338. For instance, NSDG 116 can generate a histogram of the MTCI values corresponding to each of tiles 330 (illustrated in FIGS. 17 and 18) included in normalization zone 338A and a histogram of the MTCI values corresponding to each of tiles 330 included in normalization zone 338B. For each of normalization zones 338, NSDG 116 can determine the normalization value for the respective one of normalization zones 338 as a threshold MTCI value based on the corresponding histogram of MTCI values, such as an MTCI value equal to two standard deviations above a mean of the MTCI values included in the histogram, an MTCI value equal to three standard deviations above the mean, or other whole or partial standard deviations from the mean of the corresponding MTCI values.

In the example of FIG. 19, NSDG 116 determines the normalization value for each of normalization zones 338 as a value equal to two standard deviations above the mean of the corresponding MTCI values, assumed for purposes of illustration and discussion as a value of 4.28 for normalization zone 338A and a value of 4.42 for normalization zone 338B. NSDG 116 determines, for each of normalization zones 338, a normalized MTCI value for each of tile groups 334 included in the respective one of normalization zones 338 by normalizing the average MTCI value associated with the respective one of tile groups 334 against the determined normalization value. For instance, in the example of FIG. 19, NSDG 116 normalizes the average MTCI value associated with tile group 334 (a value of 3.00 in this example) against the determined normalization value corresponding to normalization zone 338A (a value of 4.28 in this example) by dividing the average MTCI value by the normalization value associated with normalization zone 338A (a value of 4.28 in this example). As illustrated, NSDG 116 determines a normalized MTCI value associated with tile group 334A as a value of 0.7009, corresponding to a normalized MTCI value that is 70.09% of the normalization value associated with normalization zone 338A. NSDG 116 performs similar operations to determine normalized MTCI values for each of tile groups 334B, 334C and 334D.

By normalizing average MTCI values against normalization values associated with respective normalization zones, NSDG 116 removes biases from the MTCI values that could be introduced by factors other than nitrogen content within the crops, such as a general color (or “greenness”) of a hybrid or plant type. That is, differing hybrids and differing plant types can exhibit intrinsically different colors (e.g., shades of green), thereby producing differing MTCI values for a given level of nitrogen within the plant. Such intrinsic differences, without normalization among the plant type and/or hybrid, can result in differing MTCI values indicating nitrogen stress (i.e., deficiency) within the plants. NSDG 116, by normalizing average MTCI values within normalization zones, can remove such intrinsic biases, thereby enabling uniform comparison of normalized average MTCI values across the entire region of interest to determine a nitrogen stress status of growing crops within the region of interest.

NSDG 116 can, in certain examples, compare the normalized MTCI values associated with each of tile groups 334 with one or more benchmark criteria to determine the nitrogen stress status of the growing crops within the region of interest. The one or more benchmark criteria can include, e.g., a threshold normalized average MTCI value, such as seventy percent, eighty percent, ninety percent, or other percentages of the normalization value associated with a normalization zone. In some examples, the nitrogen stress status of the growing crops can indicate whether growing crops within tile groups 334 are nitrogen stressed or whether growing crops within tile groups 334 are not nitrogen stressed (i.e., a binary classification for each individual one of tile groups 334). In other examples, the nitrogen stress status can indicate a degree of nitrogen stress of growing crops within tile groups 334, such as an extent by which crops within a particular one of tile groups 334 deviates from the one or more benchmark criteria.

As such, NSDG 116 can generate a nitrogen application plan based on the determined nitrogen stress status for each of tile groups 334. The nitrogen application plan can indicate one or more nitrogen stressed areas of the region of interest at which nitrogen is to be applied and/or one or more areas of the region of interest at which nitrogen is not to be applied (e.g., one or more areas of the region of interest corresponding to one or more of tile groups 334). As an example, NSDG 116 can compare the normalized average MTCI values associated with each of tile groups 334 with a benchmark criterion, such as a threshold normalized average MTCI value of eighty percent. NSDG 116 can compare the normalized average MTCI values associated with each of tile groups 334 with the threshold normalized average MTCI value (eighty percent in this example), and can determine that those of tile groups 334 associated with a normalized average MTCI value that is greater than the threshold normalized average MTCI value do not indicate nitrogen stress within the area of the region of interest corresponding to the respective one of tile groups 334. Similarly, NSDG 116 can determine that those of tile groups 334 associated with a normalized average MTCI value that is less than the threshold normalized average MTCI value indicate nitrogen stress within the area of the region of interest corresponding to the respective one of tile groups 334.

NSDG 116 can generate a nitrogen application plan that specifies at which, if any, of tile groups 334 nitrogen is to be applied. For instance, in the example of FIG. 19, NSDG 116 can compare the normalized average MTCI values for each of tile groups 334 with a benchmark criterion of eighty percent (of the normalization value). In such an example, NSDG 116 can generate a nitrogen application plan that specifies that nitrogen is to be applied in areas of the region of interest corresponding to tile group 334A (associated with a normalized average MTCI value of 70.09 percent) and tile group 334B (associated with a normalized average MTCI value of 72.66 percent), but not in areas of the region of interest corresponding to tile group 334B (associated with a normalized average MTCI value of 95.70 percent) or tile group 334D (associated with a normalized average MTCI value of 98.64 percent). In some examples, NSDG 116 can include an indication in the nitrogen application plan that specifies an amount of nitrogen to be applied, such as a rate of nitrogen application per unit area, a total amount of nitrogen to be applied to a particular one of tile groups 334, or other indications of an amount of nitrogen to be applied. NSDG 116 can determine the amount of nitrogen to be applied based on an extent by which a normalized average MTCI value for a particular one of tile groups 334 deviates from the one or more benchmark criteria. For instance, NSDG 116 can determine increase a specified amount of nitrogen to be applied as the difference between the normalized average MTCI value for a particular one of tile groups 334 and the one or more benchmark criteria increases.

In some examples, NSDG 116 can output the nitrogen application plan as a report, an alert, an indication displayed at a user interface, or other such user-facing outputs. In certain examples, NSDG 116 can output the nitrogen application plan in a format that can be transmitted and used by application equipment, such as a fertilizer sprayer machine that traverses the region of interest, to automatically apply nitrogen at areas of the region of interest according to the nitrogen application plan. For instance, NSDG 116 can output the nitrogen application plan including GIS coordinates of boundaries of the areas of the region of interest at which nitrogen is to be applied. Accordingly, a nitrogen application device, such as a sprayer machine, irrigation equipment, or other application device can automatically apply nitrogen to those areas and, in certain examples, in an amount specified by, the nitrogen application plan.

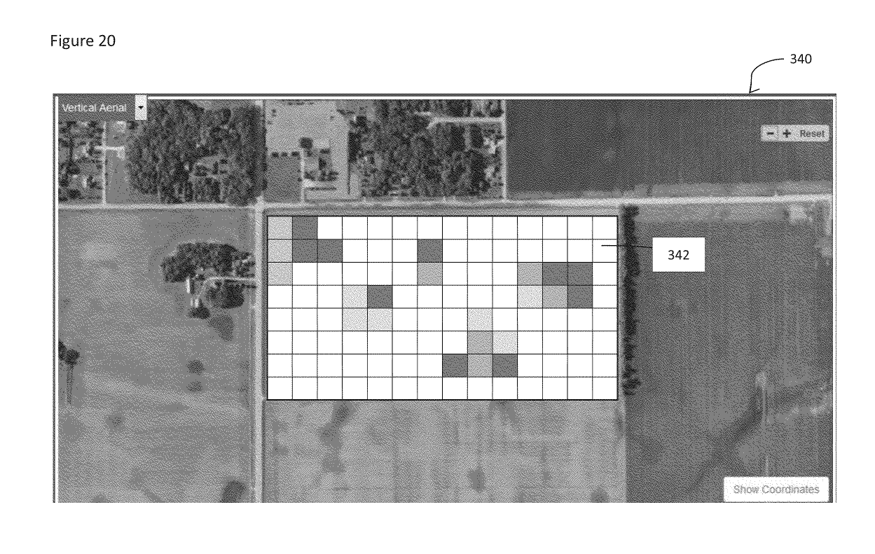

FIG. 20 is a screenshot of an example of a nitrogen application plan 340 graphically overlaid with an image of a region of interest. As illustrated in FIG. 20, nitrogen application plan 340 includes a plurality of tiles 342. Tiles 342 can correspond to, e.g., tile groups 334 of FIGS. 18 and 19. That is, a geographical area of the region of interest (a field of crops in this example) associated with each of tiles 342 can correspond to the geographical area of the region of interest associated with each of tile groups 334, such that nitrogen application plan 340 is geo-rectified with the region of interest.

Nitrogen application plan 340 specifies areas of the region of interest at which nitrogen is to be applied and areas of the region of interest at which nitrogen is not to be applied. In addition, nitrogen application plan 340, in this example, specifies an amount of nitrogen to be applied for each area of the region of interest at which nitrogen is to be applied. NSDG 116 outputs nitrogen application plan 340 as a graphical overlay with an image of the region of interest. NSDG 116 outputs an indication of those areas of the region of interest at which nitrogen is to be applied and the amount of nitrogen to be applied via shading of tiles 342. For instance, in this example, those of tiles 342 that have no shading (i.e., white tiles) indicate areas of the region of interest at which nitrogen is not to be applied. Those of tiles 342 that are shaded indicate areas of the region of interest at which nitrogen is to be applied. Similarly, a darker shading of tiles 342 indicates a relatively increased amount of nitrogen to be applied (as compared with others of tiles 342), while a lighter shading of tiles 342 indicates a relatively decreased amount of nitrogen to be applied (as compared with others of tiles 342). In certain examples, those of tiles 342 that have no shading (i.e., white tiles) can indicate, rather than areas at which no nitrogen is to be applied, areas of the region of interest at which a threshold minimum amount of nitrogen is to be applied, such as a threshold minimum of ten pounds of nitrogen per acre, twenty points of nitrogen per acre, or other threshold amounts.

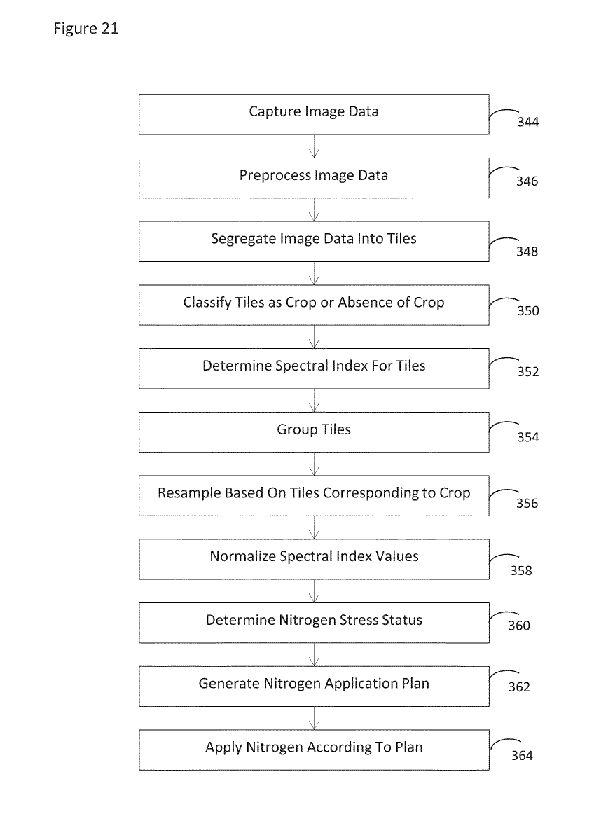

FIG. 21 is a flow diagram illustrating example operations to determine a nitrogen stress status of growing crops within a region of interest based on one or more portions of image data that correspond to the growing crops and excluding one or more portions of the image data that correspond to an absence of the growing crops. For purposes of clarity and ease of discussion, the example operations are described below within the context of nitrogen status determination and alert system 100 of FIG. 1 and the example operations of FIGS. 17-20.

Image data for a region of interest can be captured (344). For example, image data for a region of interest can be captured by an image sensor, such as a multispectral image sensor configured to capture one or more images of the region of interest. In some examples, the image sensor can be a narrowband image sensor configured to output reflectance data (e.g., percentage of reflectance) at one or more narrowband ranges of wavelengths of the electromagnetic spectrum, such as a red region, a red edge region, and/or a near infrared region of the electromagnetic spectrum. In certain examples, the image sensor can be attached to a traversal device configured to traverse the region of interest as the image sensor captures the image data. Examples of such a traversal device include, but are not limited to, aerial vehicles such as manned aerial vehicles or unmanned aerial vehicles (UAVs), satellites, irrigation equipment, or other devices capable of carrying an attached image sensor while passing over (i.e., traversing) the region of interest.

The image data for the region of interest can be pre-processed (346). As an example, NSDG 116 can assemble (e.g., “stitch”) multiple image files together to generate an image file corresponding to the entire region of interest. NSDG 116, in some examples, can apply radiometric correction and calibration to pixel values of the image data, such as when the image sensor does not perform radiometric correction and calibration operations upon capturing the image data. In certain examples, NSDG 116 can pre-process the image data to discard portion of the image data that are not associated with the region of interest or are below a threshold quality, such as a threshold clarity, brightness, contrast, or other quality metric. NSDG 116 can, in some examples, register the image data, such as when the image data originates from a plurality of image sensors. For instance, NSDG 116 can associate or transform image data from different datasets into a single coordinate system. NSDG 116 can geo-rectify the image data, such as by associating portions of the image data with latitude and longitude values corresponding to known latitude and longitude values of a geographical area represented by the respective portion of the image data. In certain examples, NSDG 116 can adjust a brightness, contrast, or other image parameters to enhance visual aspects of the image data (e.g., make a boundary more apparent). In some examples, NSDG 116 can receive image data that has already been preprocessed, such as by a camera device including the image sensor.

The received image data for the region of interest can be segregated into a plurality of tiles (348). For example, NSDG 116 can segregate the image data for the region of interest into the plurality of tiles 330. The plurality of tiles can be classified as associated with one of a crop category corresponding to growing crops and a non-crop category corresponding to an absence of growing crops (350). For example, NSDG 116 can determine a spectral index value, such as a NDVI value, for each of tiles 330. NSDG 116 can compare the determined spectral index value to a threshold value corresponding to a bifurcation between crop reflectance data and non-crop reflectance data. NSDG 116 can classify each of tiles 330 as associated with one of the crop category and the non-crop category according to the comparison.

A spectral index value can be determined for each of the plurality of tiles (352). For example, NSDG 116 can determine an MTCI value for each of tiles 330. The plurality of tiles can be grouped into a plurality of tile groups (354). For instance, NSDG 116 can group the plurality of tiles 330 to form the plurality of tile groups 334. Spectral index data corresponding to the plurality of tiles can be resampled based on spectral index values corresponding to tiles associated with the crop category (356). As an example, NSDG 116 can determine a plurality of average MTCI values for each of tile groups 334 based on spectral index values corresponding to each of the tiles associated with the respective one of tile groups 334 that are associated with a crop category. In this way, NSDG 116 can determine, for example, resampled spectral index data map 332 based on spectral index data for the region of interest corresponding to growing crops and excluding spectral index data corresponding to an absence of the growing crops.

The spectral index data values can be normalized (358). For instance, NSDG 116 can determine two or more normalization zones for the region of interest, such as normalization zones 338. Each of the normalization zones can include at least one of the plurality of tile groups 334. NSDG 116 can determine, for each of normalization zones 338, a normalization value for the respective one of normalization zones 338 to determine a plurality of normalization values. As an example, NSDG 116 can determine the normalization value for each of normalization zones 338 as a value equal to two standard deviations above a mean of the average spectral index values included in the respective one of normalization zones 338. NSDG 116 can normalize, for each of normalization zones 338, the average spectral index values for each of tile groups 334 included in a respective one of normalization zones 338, such as by dividing the average spectral index value for each of tile groups 334 by the normalization value corresponding to the respective one of normalization zones 338.

A nitrogen stress status for growing crops within the region of interest can be determined (360). For instance, NSDG 116 can determine a nitrogen stress status for growing crops within the region of interest as the normalized average MTCI value associated with each of tile groups 334. A nitrogen application plan can be generated (362). As an example, NSDG 116 can generate nitrogen application plan 340 that indicates one or more areas of the region of interest at which nitrogen is to be applied and/or one or more areas of the region of interest at which nitrogen is not to be applied. Nitrogen can be applied to the region of interest according to the nitrogen application plan (364). For instance, nitrogen application plan 340 can be uploaded to nitrogen application equipment, such as sprayer machines, irrigation equipment, or other application equipment that can apply nitrogen to those areas of the region at which the nitrogen application plan indicates that nitrogen should be applied.

Accordingly, techniques described herein can enable a computing device, such as server device 104, to utilize spectral index values (e.g., MTCI values) to determine a nitrogen stress status of growing crops based on image data corresponding to growing crops and excluding image data corresponding to an absence of growing crops. Moreover, the techniques can enable the use of MTCI values, which are sensitive to low levels of nitrogen stress, to be effectively used in large-scale agricultural environments via image data of fields of crops. In this way, techniques of this disclosure enhance the field of spectral imaging technology to ascertain nitrogen levels (or a nitrogen stress status) of growing crops, thereby helping to increase crop yield while decreasing both a cost of nitrogen fertilizer application and the possible negative environmental impacts associated with current fertilizer application techniques.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method comprising:
receiving, by a computing device, image data for a region of interest that includes growing crops;
identifying, by the computing device, one or more portions of the image data that correspond to the growing crops and one or more portions of the image data that correspond to an absence of the growing crops; and
determining, by the computing device, based on the one or more portions of the image data that correspond to the growing crops and excluding the one or more portions of the image data that correspond to the absence of the growing crops, a nitrogen stress status of the growing crops within the region of interest.

2. The method of claim 1, wherein the image data comprises multispectral image data comprising reflectance data within a plurality of wavelength ranges.

3. The method of claim 2, wherein the plurality of wavelength ranges comprises a first wavelength range, a second wavelength range, and a third wavelength range.

4. The method of claim 1, further comprising:
segregating, by the computing device, the image data for the region of interest into a plurality of tiles, each tile from the plurality of tiles including image data corresponding to a different geographical portion of the region of interest;
wherein identifying the one or more portions of the image data that correspond to the growing crops and the one or more portions of the image data that correspond to the absence of the growing crops comprises identifying, for each tile from the plurality of tiles, whether the image data included in the respective tile corresponds to the growing crops or whether the image data included in the respective tile corresponds to the absence of the growing crops; and
wherein determining the nitrogen stress status of the growing crops within the region of interest comprises determining the nitrogen stress status of growing crops included in each different geographical portion of the region of interest based on the image data included in the plurality of tiles that correspond to the growing crops and excluding the image data included in the plurality of tiles that correspond to the absence of the growing crops.

5. The method of claim 4, wherein determining the nitrogen stress status of the growing crops within the region of interest comprises determining, for each of the plurality of tiles that correspond to the growing crops and excluding tiles that correspond to the absence of growing crops, a spectral index value associated with a chlorophyll content of the growing crops within the geographical portion of the region of interest corresponding to the respective tile.

6. The method of claim 4, wherein determining the nitrogen stress status of the growing crops within the region of interest comprises determining, for each of the plurality of tiles, a spectral index value associated with a nitrogen content of the growing crops within the geographical portion of the region of interest corresponding to the respective tile.

7. The method of claim 6, wherein each of the plurality of tiles corresponds to a different pixel of the image data for the region of interest.

8. The method of claim 6, wherein determining the spectral index value comprises determining a Medium Resolution Imaging Spectrometer (MERIS) Terrestrial Chlorophyll Index (MTCI) value.

9. The method of claim 8, wherein determining the MTCI value comprises determining the MTCI value according to the following equation:
$$I = \frac{NIR - RedEdge}{RedEdge - Red}$$
wherein I is the MTCI value;
wherein NIR is a wavelength in a near-infrared region of the electromagnetic spectrum;
wherein Red Edge is a wavelength in a red edge region of the electromagnetic spectrum; and
wherein Red is a wavelength in a red region of the electromagnetic spectrum.

10. The method of claim 6, wherein determining the nitrogen stress status of the growing crops within the region of interest further comprises:
grouping the plurality of tiles into a plurality of tile groups; and
averaging, for each of the plurality of tile groups, spectral index values of tiles included in the respective tile group that correspond to the growing crops and excluding spectral index values of tiles included in the respective tile group that correspond to the absence of the growing crops to determine an average spectral index value corresponding to the respective tile group;
wherein determining the nitrogen stress status of the growing crops within the region of interest comprises determining the nitrogen stress status of the growing crops based on the average spectral index values for each of the plurality of tile groups.

11. The method of claim 10, further comprising:
determining, by the computing device, two or more normalization zones within the region of interest, each of the two or more normalization zones including at least one of the plurality of tile groups;
wherein determining the nitrogen stress status of the growing crops within the region of interest further comprises:
determining, for each of the two or more normalization zones, a normalization value for the respective normalization zone to determine plurality of normalization values;
normalizing, for each of the two or more normalization zones, the average spectral index values corresponding to each tile group included in the respective normalization zone against a respective one of the plurality of normalization values to determine a plurality of normalized average spectral index values; and
determining the nitrogen stress status of the growing crops within the region of interest based on the normalized average spectral index values.

12. The method of claim 11, wherein determining the respective normalization value for each of the two or more normalization zones comprises determining the normalization value as a value equal to two standard deviations above a mean of the spectral index values associated with tiles included in the respective normalization zone.

13. The method of claim 11, wherein each of the two or more normalization zones corresponds to a different hybrid of growing crops within the region of interest.

14. The method of claim 11, wherein determining nitrogen stress status of the growing crops within the region of interest comprises comparing each of the normalized average spectral index values to one or more benchmark criteria.

15. The method of claim 1, further comprising:
generating, by the computing device, a nitrogen application plan based on the determined nitrogen stress status of the growing crops within the region of interest, the nitrogen application plan indicating one or more nitrogen-stressed areas of the region of interest where nitrogen is to be applied.

16. The method of claim 15, further comprising:
applying nitrogen to the one or more nitrogen-stressed areas of the region of interest.

17. The method of claim 1, further comprising:
traversing the region of interest with an image sensor to capture the image data for the region of interest.

18. The method of claim 17, wherein traversing the region of interest with the image sensor comprises traversing the region of interest with the image sensor carried by an unmanned aerial vehicle (UAV).

19. An apparatus comprising:
at least one processor; and
a computer-readable storage medium encoded with instructions that, when executed, cause the at least one processor to:
receive image data for a region of interest that includes growing crops;
identify one or more portions of the image data that correspond to the growing crops and one or more portions of the image data that correspond to an absence of the growing crops; and
determine, based on the one or more portions of the image data that correspond to the growing crops and excluding the one or more portions of the image data that correspond to the absence of the growing crops, a nitrogen stress status of the growing crops within the region of interest.

20. A system comprising:
a traversal device configured to traverse a region of interest that includes growing crops;
an image sensor configured to be carried by the traversal device and to capture image data including reflectance data within a plurality of narrowband wavelength ranges;
at least one processor; and
a computer-readable storage medium encoded with instructions that, when executed, cause the at least one processor to:
receive the captured image data for the region of interest from the image sensor;
identify, based on the reflectance data, one or more portions of the image data that correspond to the growing crops and one or more portions of the image data that correspond to an absence of the growing crops;
determine, based on the reflectance data, at least one spectral index value associated with a nitrogen content of the growing crops within the region of interest; and
determine, based on the at least one spectral index value, a nitrogen stress status of the growing crops within the region of interest.
